(19) United States
(12) Patent Application Publication
(10) Pub. No.: US 2017/0091794 A1
(43) Pub. Date: Mar. 30, 2017

(54) METHODS AND APPARATUS TO DETERMINE RATINGS DATA FROM POPULATION SAMPLE DATA HAVING UNRELIABLE DEMOGRAPHIC CLASSIFICATIONS

(71) Applicant: The Nielsen Company (US), LLC, New York, NY (US)

(72) Inventors: Michael Sheppard, Brooklyn, NY (US); Jonathan Sullivan, Natick, MA (US); Peter Lipa, Tucson, AZ (US); Alejandro Terrazas, Santa Cruz, CA (US); Paul Donato, New York, NY (US)

(21) Appl. No.: 14/866,335

(22) Filed: Sep. 25, 2015

(51) Int. Cl. G06Q 30/02

(52) U.S. Cl. CPC G06Q 30/0204

(57) ABSTRACT

Methods and apparatus to determine ratings data from population sample data having unreliable demographic classifications are disclosed. An example method includes receiving, at an audience measurement entity (AME), a first request sent from a first type of device via a communications network; sending a request for demographic information corresponding to requests received at the AME from the first type of device, the requests including the first request; obtaining a misattribution matrix; generating a multinomial distribution from the misattribution matrix; generating samples of the multinomial distribution; converting the samples to misattribution matrices; and applying a vector to the plurality of misattribution matrices to estimate a first number of audience members who are attributable to the second demographic group, the vector representing a second number of audience members who are associated with the first demographic group based on the demographic information.

### FIELD OF THE DISCLOSURE

This disclosure relates generally to audience measurement and, more particularly, to methods and apparatus to determine ratings data from population sample data having unreliable demographic classifications.

### BACKGROUND

Traditionally, audience measurement entities determine compositions of audiences exposed to media by monitoring registered panel members and extrapolating their behavior onto a larger population of interest. That is, an audience measurement entity enrolls people that consent to being monitored into a panel and collects relatively highly accurate demographic information from those panel members via, for example, in-person, telephonic, and/or online interviews. The audience measurement entity then monitors those panel members to determine media exposure information identifying media (e.g., television programs, radio programs, movies, streaming media, etc.) exposed to those panel members. By combining the media exposure information with the demographic information for the panel members, and by extrapolating the result to the larger population of interest, the audience measurement entity can determine detailed audience measurement information such as media ratings, audience composition, reach, etc. This audience measurement information can be used by advertisers to, for example, place advertisements with specific media to target audiences of specific demographic compositions.

More recent techniques employed by audience measurement entities monitor exposure to Internet accessible media or, more generally, online media. These techniques expand the available set of monitored individuals to a sample population that may or may not include registered panel members. In some such techniques, demographic information for these monitored individuals can be obtained from one or more database proprietors (e.g., social network sites, multi-service sites, online retailer sites, credit services, etc.) with which the individuals subscribe to receive one or more online services. However, the demographic information available from these database proprietor(s) may be self-reported and, thus, unreliable or less reliable than the demographic information typically obtained for panel members registered by an audience measurement entity.

### BRIEF DESCRIPTION OF THE DRAWINGS

FIG. 1 illustrates example client devices that report audience impressions for Internet-based media to impression collection entities to facilitate identifying numbers of impressions and sizes of audiences exposed to different Internet-based media.

FIG. 2 is an example communication flow diagram illustrating an example manner in which an example audience measurement entity and an example database proprietor can collect impressions and demographic information associated with a client device, and can further determine ratings data from population sample data having unreliable demographic classifications in accordance with the teachings of this disclosure.

FIG. 3 is a block diagram of an example implementation of the probabilistic ratings determiner of FIG. 2.

FIG. 4 is a block diagram of an example implementation of the sample generator of FIG. 3.

FIG. 5 is a block diagram of an example implementation of the ratings data determiner of FIG. 3.

FIGS. 6A and 6B are a flowchart representative of example machine readable instructions that may be executed to implement the example probabilistic ratings determiner of FIGS. 2 and/or 3 to determine ratings data.

FIG. 7 is a flowchart representative of example machine readable instructions that may be executed to implement the sample generator of FIG. 3 to generate samples of a misattribution matrix.

FIG. 8 is a flowchart representative of example machine readable instructions that may be executed to apply impression information to a misattribution matrix to obtain corrected impression information.

FIG. 9 is an example method that may be performed by the structures of FIGS. 1, 3, 4, and 5.

FIG. 10 is another example method that may be performed by the structures of FIGS. 1, 3, 4, and 5.

FIG. 11 is another example method that may be performed by the structures of FIGS. 1, 3, 4, and 5.

FIG. 12 is a block diagram of an example processor platform structured to execute the instructions of FIGS. 6A-6B, 7, and/or 8 to implement the probabilistic ratings determiner of FIGS. 2, 3, 4, and/or 5.

Wherever appropriate, the same reference numbers will be used throughout the drawing(s) and accompanying written description to refer to the same or like parts.

### DETAILED DESCRIPTION

When measuring impressions and/or determining audience composition of online media, the impressions and/or audience members may be attributed to demographic groups (e.g., by requesting demographic information from a database proprietor that is capable of recognizing the audience member). In accordance with the disclosure, misattribution matrices are used to correct numbers of impressions and/or audience members that are attributed to demographic group(s) to more accurately represent the composition of persons exposed to the media.

In a N×N misattribution matrix, N categories are compared against each other. Such a misattribution matrix compares a stated value in each of the N categories with a true value. In such examples, the samples used to generate the misattribution matrix are obtained from a proportional sample of a population. For example, when measuring audience members and/or impressions of media occurring on a computing device, the stated value may be a characteristic (e.g., an age and/or gender) of the person as recognized using a device or user identifier. The true value is the actual (e.g., real world, ground truth) characteristic of the audience member to whom the media was presented. Thus, the misattribution matrix may describe, for 100 observed audience members (or impressions) recognized (or observed) to be in a demographic group (e.g., by a database proprietor in response to an impression request), the number of the 100 audience members (or impressions) that are “truthfully” in each demographic group, including the observed group. However, a problem with misattribution matrices of this type is that the misattribution matrix may suffer from sampling error. That is, the misattribution matrix may not be perfectly representative of the actual relationship between the stated or observed value (e.g., recognized by the database proprietor) and the actual value (e.g., the truth).

When analyzing audience measurement information to determine the demographic characteristics of the audience, examples disclosed herein use a misattribution matrix to correct for observed numbers of audience members and/or observed numbers of impressions occurring for an item of media. Further, disclosed examples correct for sampling errors that may otherwise be present in the misattribution matrix. For instance, some disclosed examples use Monte Carlo methods to generate multiple samples of the misattribution matrix based on an expected value of the misattribution matrix, variance values of the elements of the misattribution matrix, and/or covariance values of the misattribution matrix. The expected value of the misattribution matrix, the variance of the misattribution matrix, and the covariances of the misattribution matrix may then be determined from the samples. Additionally or alternatively, disclosed examples correct for sampling errors that may be present in the probabilistically determined observed numbers of audience members and/or probabilistically determined observed numbers of impressions. In some examples, Monte Carlo methods are used to perform trials for both the misattribution matrix and the observed numbers of audience members and/or impressions.

In this patent, the term “variance” is used in the sense of the fields of statistics and probability. As such the term “variance” is defined to be a measure of how data is distributed about an average or expected value. In this patent, the term “covariance” is also used in the sense of the fields of statistics and probability. Accordingly, the term “covariance” is defined to be a measure of the strength of the correlation between two or more sets of variates. As used herein, the term “vector” refers to any ordered set of numbers.

Disclosed example methods to determine ratings data include sending a first request for demographic information corresponding to second requests received at the audience measurement entity, and determining a first number of audience members who are associated with a first demographic group based on the demographic information and based on the second requests received at the audience measurement entity. Disclosed example methods further include reducing an error present in a misattribution matrix, the misattribution matrix describing a probability that an audience member observed to be in the first demographic group is actually in a second demographic group. The reducing of the error includes generating a multinomial distribution from the misattribution matrix, generating samples of the multinomial distribution, converting the samples to a plurality of misattribution matrices, and applying the first number of audience members to the plurality of misattribution matrices to estimate a second number of audience members who are attributable to the second demographic group. Disclosed example methods further include determining ratings data for media based on the second number of audience members who are attributable to the second demographic group.

Some disclosed example methods include applying the first number of audience members to the plurality of misattribution matrices includes performing a matrix multiplication of a vector and each of the plurality of misattribution matrices to obtain corresponding result matrices, in which the vector includes the first number of audience members, and the corresponding result matrices include estimates of the second number of audience members.

Some disclosed example methods include estimating a first expected number of audience members that are attributable to the first demographic group based on the applying of the first number of audience members to a first one of the plurality of misattribution matrices, determining a variance of the first expected number, and determining a covariance between the first expected number and a second expected number of third audience members that are attributable to the second demographic group based on the applying of the first number of audience members to the first one of the plurality of misattribution matrices.

Some disclosed example methods further include estimating the first expected number, determining the variance of the first expected number, and determining the covariance of the first expected number for each of the plurality of misattribution matrices.

Some disclosed example methods further include applying a third number of audience members to the plurality of misattribution matrices to estimate a fourth number of audience members who are attributable to the first demographic group, in which the third number of audience members are attributed to the second demographic group, and in which the third number of audience members correspond to the second requests received at the audience measurement entity. Some disclosed example methods further include applying a fifth number of audience members to the plurality of misattribution matrices to estimate a sixth number of audience members who are attributable to the first demographic group, in which the fifth number of audience members are attributed to the first demographic group, and in which the fifth number of audience members correspond to the second requests received at the audience measurement entity. Some disclosed example methods further include applying a seventh number of audience members to the plurality of misattribution matrices to estimate an eighth number of audience members who are attributable to the second demographic group, in which the seventh number of audience members are attributed to the second demographic group, and in which the seventh number of audience members correspond to the second requests received at the audience measurement entity. In some disclosed examples, a first sum of audience members attributed to ones of the first and second demographic groups is equal to a second sum of audience members determined to be attributable to the ones of the first and second demographic groups, in which the first sum includes the first number, the third number, the fifth number, and the seventh number, and the second sum includes the second number, the fourth number, the sixth number, and the eighth number. In some examples, the ratings data are based on the first sum and the second sum.

In some disclosed example methods, the generating of the ratings data reduces or eliminates at least one of a normalization process or a data scaling process. In some disclosed examples, the demographic information includes the first number of audience members attributed to the first demographic group who correspond to the second requests.

Disclosed example devices to determine ratings data for online accessible media include a date interface, an audience estimate generator, a matrix-to-distribution converter, a sample randomizer, a distribution-to-matrix converter, an attribution corrector, and a ratings data determiner. In some disclosed examples, the data interface sends a first request for demographic information corresponding to second requests received at an audience measurement entity. In some disclosed examples, the audience estimate generator determines a first number of audience members who are associated with a first demographic group based on the demographic information and based on the second requests received at the audience measurement entity. In some disclosed examples, the matrix-to-distribution converter generates a multinomial distribution from a misattribution matrix, in which the misattribution matrix describes a probability that an audience member observed to be in the first demographic group is actually in a second demographic group. In some disclosed examples, the sample randomizer generates samples of the multinomial distribution. In some disclosed examples, the distribution-to-matrix converter converts the samples to a plurality of misattribution matrices. In some disclosed examples, the attribution corrector applies the first number of audience members to the plurality of misattribution matrices to estimate a second number of audience members who are attributable to the second demographic group to thereby reduce an error present in the misattribution matrix. In some disclosed examples, the ratings data determiner determines ratings data for media based on the second number of audience members who are attributable to the second demographic group.

Some disclosed example devices further include an expected value calculator to estimate a first expected number of audience members that are attributable to the first demographic group based on the applying of the first number of audience members to a first one of the plurality of misattribution matrices. Some disclosed example devices further include a variance calculator to determine a variance of the first expected number, and determine a covariance between the first expected number and a second expected number of audience members that are attributable to the second demographic group based on the applying of the first number of audience members to the first one of the plurality of misattribution matrices.

In some disclosed examples, the expected value calculator estimates the first expected number and the variance calculator determines the variance of the first expected number and determine the covariance of the first expected number for each of the plurality of misattribution matrices.

In some disclosed examples, the attribution corrector applies a third number of audience members to the plurality of misattribution matrices to estimate a fourth number of audience members who are attributable to the first demographic group, in which the third number of audience members are attributed to the second demographic group, and in which the third number of audience members correspond to the second requests. In some disclosed examples, the attribution corrector applies a fifth number of audience members to the plurality of misattribution matrices to estimate a sixth number of audience members who are attributable to the first demographic group, in which the fifth number of audience members are attributed to the first demographic group, and in which the fifth number of audience members correspond to the second requests. In some disclosed examples, the attribution corrector applies a seventh number of audience members to the plurality of misattribution matrices to estimate an eighth number of audience members who are attributable to the second demographic group, in which the seventh number of audience members are attributed to the second demographic group, and in which the seventh number of audience members correspond to the second requests. In some disclosed examples, a first sum of audience members attributed to ones of the first and second demographic groups is equal to a second sum of audience members determined to be attributable to the ones of the first and second demographic groups, in which the first sum includes the first number, the third number, the fifth number, and the seventh number, and the second sum includes the second number, the fourth number, the sixth number, and the eighth number. In some disclosed examples, the ratings data are based on the first sum and the second sum.

In some disclosed example devices, the attribution corrector applies the first number of audience members to the plurality of misattribution matrices by, for each of the misattribution matrices, determining respective portions of the first number of audience members that 1) have been attributed to the first demographic group and 2) are attributable to each of a plurality of demographic groups, including the first demographic group, based on the misattribution matrix. In some disclosed examples, the demographic information includes the first number of audience members attributed to the first demographic group that correspond to the second requests.

Some other disclosed example methods include sending, from an audience measurement entity, a first request for demographic information corresponding to second requests received at the audience measurement entity. Some disclosed example methods further include reducing a probability error present in the demographic information by estimating a first number of audience members attributed to a first demographic group based on the demographic information and the second requests; determining a variance of the first number; determining a covariance between the first number and a second number of second audience members that are attributed to a second demographic group based on the demographic information and the second requests; obtaining a misattribution matrix describing a probability that an audience member observed to be in the first demographic group based on the demographic information is attributable to the second demographic group; and applying the first number of audience members attributed to the first demographic group to the misattribution matrix to estimate a third number of audience members that are attributable to the second demographic group. Some disclosed example methods further include determining ratings data for media based on the third number of audience members that are attributable to the second demographic group.

Some other disclosed example methods include sending, from an audience measurement entity, a first request for demographic information corresponding to second requests received at the audience measurement entity. Some example methods further include obtaining an N×N misattribution matrix describing probabilities that audience members observed to be in a first one of N demographic groups based on the demographic information are attributable to respective ones of the N demographic groups. Some disclosed example methods further include reducing a first probability error present in a first number of audience members that are attributed to a first demographic group and a second probability error present in data used to generate the misattribution matrix by: generating pseudorandom samples of the misattribution matrix using a distribution corresponding to the probabilities in the misattribution matrix; calculating second numbers of audience members from the pseudorandom samples of the misattribution matrix by applying N numbers of audience members to the pseudorandom samples of the misattribution matrix, in which the N numbers of audience members corresponding to the second requests and being attributed to corresponding ones of the N demographic groups based on the demographic information; and determining second numbers of audience members for the media for corresponding ones of the N demographic groups based on the generated estimates of the audience members. Some disclosed example methods further include determining ratings data for the media based on the number of audience members for the media for each of the N demographic groups.

Some disclosed example methods further include determining a variance of the number of audience members for the media for each of the N demographic groups. Some disclosed example methods further include determining, for each of the N demographic groups, a covariance with the others of the N demographic groups.

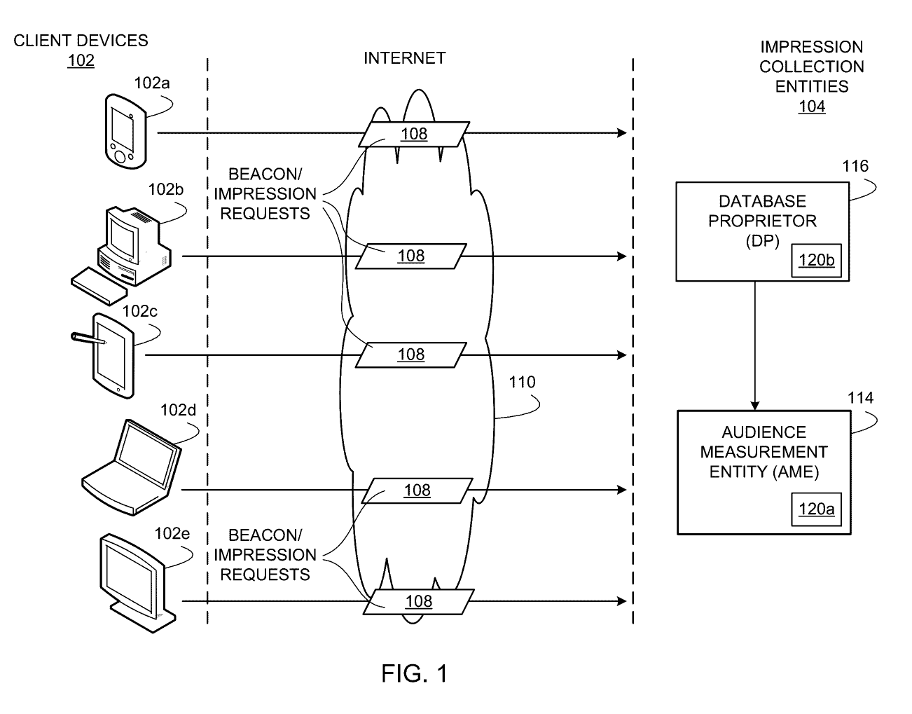

Turning to the figures, FIG. 1 illustrates example client devices 102 (e.g., 102a, 102b, 102c, 102d, 102e) that report audience impressions for online (e.g., Internet-based) media to impression collection entities 104 to facilitate determining numbers of impressions and sizes of audiences exposed to different online media. An “impression” generally refers to an instance of an individual's exposure to media (e.g., content, advertising, etc.). As used herein, the term “impression collection entity” refers to any entity that collects impression data, such as, for example, audience measurement entities and database proprietors that collect impression data.

The client devices 102 of the illustrated example may be implemented by any device capable of accessing media over a network. For example, the client devices 102 may be a computer, a tablet, a mobile device, a smart television, or any other Internet-capable device or appliance. Examples disclosed herein may be used to collect impression information for any type of media, including content and/or advertisements. Media may include advertising and/or content delivered via web pages, streaming video, streaming audio, Internet protocol television (IPTV), movies, television, radio and/or any other vehicle for delivering media. In some examples, media includes user-generated media that is, for example, uploaded to media upload sites, such as YouTube, and subsequently downloaded and/or streamed by one or more other client devices for playback. Media may also include advertisements. Advertisements are typically distributed with content (e.g., programming). Traditionally, content is provided at little or no cost to the audience because it is subsidized by advertisers that pay to have their advertisements distributed with the content. As used herein, “media” refers collectively and/or individually to content and/or advertisement(s).

In the illustrated example, the client devices 102 employ web browsers and/or applications (e.g., apps) to access media. Some of the media includes instructions that cause the client devices 102 to report media monitoring information to one or more of the impression collection entities 104. That is, when a client device 102 of the illustrated example accesses media that is instantiated with (e.g., linked to, embedded with, etc.) one or more monitoring instructions, a web browser and/or application of the client device 102 executes the one or more instructions (e.g., monitoring instructions, sometimes referred to herein as beacon instruction(s)) in the media executes the beacon instruction(s) cause the executing client device 102 to send a beacon request or impression request 108 to one or more impression collection entities 104 via, for example, the Internet 110. The beacon request 108 of the illustrated example includes information about the access to the instantiated media at the corresponding client device 102 generating the beacon request. Such beacon requests allow monitoring entities, such as the impression collection entities 104, to collect impressions for different media accessed via the client devices 102. In this manner, the impression collection entities 104 can generate large impression quantities for different media (e.g., different content and/or advertisement campaigns). Examples techniques for using beacon instructions and beacon requests to cause devices to collect impressions for different media accessed via client devices are further disclosed in at least U.S. Pat. No. 6,108,637 to Blumenau and U.S. Pat. No. 8,370,489 to Mainak, et al., which are incorporated herein by reference in their respective entireties.

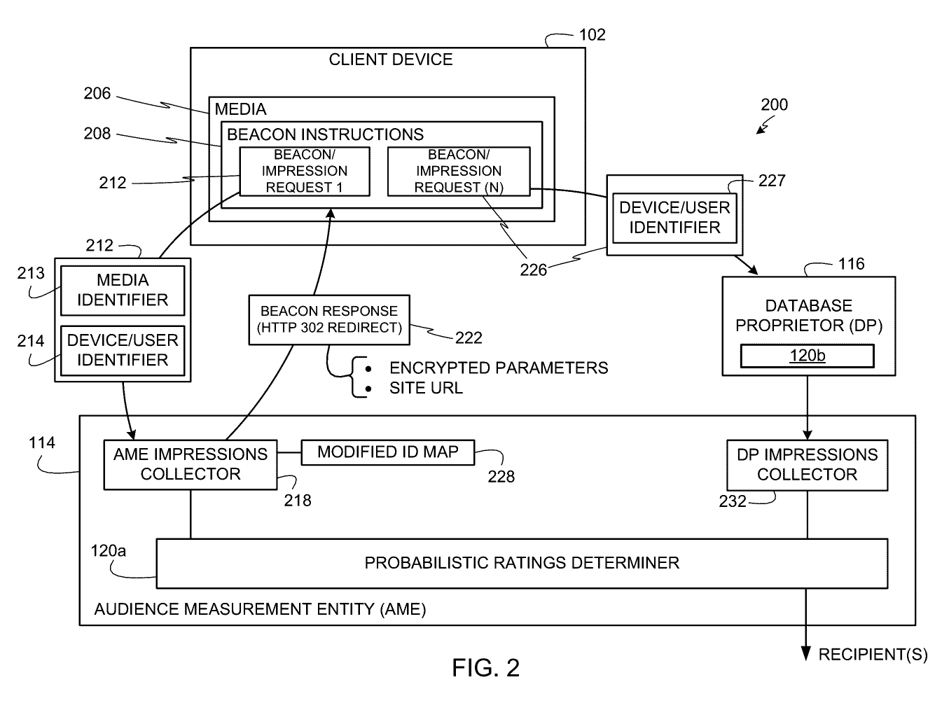

The impression collection entities 104 of the illustrated example include an example audience measurement entity (AME) 114 and an example database proprietor (DP) 116. In the illustrated example, the AME 114 does not provide the media to the client devices 102 and is a trusted (e.g., neutral) third party (e.g., The Nielsen Company, LLC) for providing accurate media access statistics. In the illustrated example, the database proprietor 116 is one of many database proprietors that operate on the Internet to provide one or more services to. Such services may include, but are not limited to, email services, social networking services, news media services, cloud storage services, streaming music services, streaming video services, online shopping services, credit monitoring services, etc. Example database proprietors include social network sites (e.g., Facebook, Twitter, MySpace, etc.), multi-service sites (e.g., Yahoo!, Google, etc.), online shopping sites (e.g., Amazon.com, Buy.com, etc.), credit services (e.g., Experian), and/or any other type(s) of web service site(s) that maintain user registration records. In examples disclosed herein, the database proprietor 116 maintains user account records corresponding to users registered for Internet-based services provided by the database proprietors. That is, in exchange for the provision of services, subscribers register with the database proprietor 116. As part of this registration, the subscriber may provide detailed demographic information to the database proprietor 116. The demographic information may include, for example, gender, age, ethnicity, income, home location, education level, occupation, etc. In the illustrated example of FIG. 1, the database proprietor 116 sets a device/user identifier (e.g., an identifier described below in connection with FIG. 2) on a subscriber's client device 102 that enables the database proprietor 116 to identify the subscriber in subsequent interactions.

In the illustrated example, when the database proprietor 116 receives a beacon/impression request 108 from a client device 102, the database proprietor 116 requests the client device 102 to provide the device/user identifier that the database proprietor 116 had previously set for the client device 102. The database proprietor 116 uses the device/user identifier corresponding to the client device 102 to identify demographic information in its user account records corresponding to the subscriber of the client device 102. In this manner, the database proprietor 116 can generate “demographic impressions” by associating demographic information with an impression for the media accessed at the client device 102. Thus, as used herein, a “demographic impression” is defined to be an impression that is associated with one or more characteristic(s) (e.g., a demographic characteristic) of the person(s) exposed to the media in the impression. Through the use of demographic impressions, which associate monitored (e.g., logged) media impressions with demographic information, it is possible to measure media exposure and, by extension, infer media consumption behaviors across different demographic classifications (e.g., groups) of a sample population of individuals.

In the illustrated example, the AME 114 establishes a panel of users who have agreed to provide their demographic information and to have their Internet browsing activities monitored. When an individual joins the AME panel, the person provides detailed information concerning the person's identity and demographics (e.g., gender, age, ethnicity, income, home location, occupation, etc.) to the AME 114. The AME 114 sets a device/user identifier (e.g., an identifier described below in connection with FIG. 2) on the person's client device 102 that enables the AME 114 to identify the panelist.

In the illustrated example, when the AME 114 receives a beacon request 108 from a client device 102, the AME 114 requests the client device 102 to provide the AME 114 with the device/user identifier the AME 114 previously set for the client device 102. The AME 114 uses the device/user identifier corresponding to the client device 102 to identify demographic information in its user AME panelist records corresponding to the panelist of the client device 102. In this manner, the AME 114 can generate demographic impressions by associating demographic information with an audience impression for the media accessed at the client device 102 as identified in the corresponding beacon request.

In the illustrated example, the database proprietor 116 reports demographic impression data to the AME 114. To preserve the anonymity of its subscribers, the demographic impression data may be anonymous demographic impression data and/or aggregated demographic impression data. In the case of anonymous demographic impression data, the database proprietor 116 reports user-level demographic impression data (e.g., which is resolvable to individual subscribers), but with any personally identifiable information (PII) removed from or obfuscated (e.g., scrambled, hashed, encrypted, etc.) in the reported demographic impression data. For example, anonymous demographic impression data, if reported by the database proprietor 116 to the AME 114, may include respective demographic impression data for each device 102 from which a beacon request 108 was received, but with any personal identification information removed from or obfuscated in the reported demographic impression data. In the case of aggregated demographic impression data, individuals are grouped into different demographic classifications, and aggregate demographic data (e.g., which is not resolvable to individual subscribers) for the respective demographic classifications is reported to the AME 114. In some cases, the aggregated data is aggregated demographic impression data. In others, the database proprietor is not provided with impression data that is not resolvable to a particular media name (but may instead be given a code or the like that the AME 114 can map to the code) and the reported aggregated demographic data may thus not be mapped to impressions or may be mapped to the code(s) associated with the impressions.

Aggregate demographic data, if reported by the database proprietor 116 to the AME 114, may include first demographic data aggregated for devices 102 associated with demographic information belonging to a first demographic classification (e.g., a first age group, such as a group which includes ages less than 18 years old), second demographic data for devices 102 associated with demographic information belonging to a second demographic classification (e.g., a second age group, such as a group which includes ages from 18 years old to 34 years old), etc.

As mentioned above, demographic information available for subscribers of the database proprietor 116 may be unreliable, or less reliable than the demographic information obtained for panel members registered by the AME 114. There are numerous social, psychological and/or online safety reasons why subscribers of the database proprietor 116 may inaccurately represent or even misrepresent their demographic information, such as age, gender, etc. Accordingly, one or more of the AME 114 and/or the database proprietor 116 determine sets of classification probabilities for respective individuals in the sample population for which demographic data is collected. A given set of classification probabilities represents likelihoods that a given individual in a sample population belongs to respective ones of a set of possible demographic classifications. For example, the set of classification probabilities determined for a given individual in a sample population may include a first probability that the individual belongs to a first one of possible demographic classifications (e.g., a first age classification, such as a first age group), a second probability that the individual belongs to a second one of the possible demographic classifications (e.g., a second age classification, such as a second age group), etc. In some examples, the AME 114 and/or the database proprietor 116 determine the sets of classification probabilities for individuals of a sample population by combining, with models, decision trees, etc., the individuals' demographic information with other available behavioral data that can be associated with the individuals to estimate, for each individual, the probabilities that the individual belongs to different possible demographic classifications in a set of possible demographic classifications. Example techniques for reporting demographic data from the database proprietor 116 to the AME 114, and for determining sets of classification probabilities representing likelihoods that individuals of a sample population belong to respective possible demographic classifications in a set of possible demographic classifications, are further disclosed in at least U.S. Patent Publication No. 2012/0072469 (Perez et al.) and U.S. patent application Ser. No. 14/604,394 (now U.S. patent Ser. No. ______) to (Sullivan et al.), which are incorporated herein by reference in their respective entireties.

In the illustrated example, one or both of the AME 114 and the database proprietor 116 include example probabilistic ratings determiners to determine ratings data from population sample data having unreliable demographic classifications in accordance with the teachings of this disclosure. For example, the AME 114 may include an example probabilistic ratings determiner 120a and/or the database proprietor 116 may include an example probabilistic ratings determiner 120b. As disclosed in further detail below, the probabilistic ratings determiner(s) 120a and/or 120b of the illustrated example process sets of classification probabilities determined by the AME 114 and/or the database proprietor 116 for monitored individuals of a sample population (e.g., corresponding to a population of individuals associated with the devices 102 from which beacon requests 108 were received) to estimate parameters characterizing population attributes (also referred to herein as population attribute parameters) associated with the set of possible demographic classifications.

In some examples, such as when the probabilistic ratings determiner 120b is implemented at the database proprietor 116, the sets of classification probabilities processed by the probabilistic ratings determiner 120b to estimate the population attribute parameters include personal identification information which permits the sets of classification probabilities to be associated with specific individuals. Associating the classification probabilities enables the probabilistic ratings determiner 120b to maintain consistent classifications for individuals over time, and the probabilistic ratings determiner 120b may scrub the PII from the impression information prior to reporting impressions based on the classification probabilities. In some examples, such as when the probabilistic ratings determiner 120a is implemented at the AME 114, the sets of classification probabilities processed by the probabilistic ratings determiner 120a to estimate the population attribute parameters are included in reported, anonymous demographic data and, thus, do not include PII. However, the sets of classification probabilities can still be associated with respective, but unknown, individuals using, for example, anonymous identifiers (e.g., hashed identifier, scrambled identifiers, encrypted identifiers, etc.) included in the anonymous demographic data.

In some examples, such as when the probabilistic ratings determiner 120a is implemented at the AME 114, the sets of classification probabilities processed by the probabilistic ratings determiner 120a to estimate the population attribute parameters are included in reported, aggregate demographic impression data and, thus, do not include personal identification and are not associated with respective individuals but, instead, are associated with respective aggregated groups of individuals. For example, the sets of classification probabilities included in the aggregate demographic impression data may include a first set of classification probabilities representing likelihoods that a first aggregated group of individuals belongs to respective possible demographic classifications in a set of possible demographic classifications, a second set of classification probabilities representing likelihoods that a second aggregated group of individuals belongs to the respective possible demographic classifications in the set of possible demographic classifications, etc.

Using the estimated population attribute parameters, the probabilistic ratings determiner(s) 120a and/or 120b of the illustrated example then determine ratings data for media, as disclosed in further detail below. For example, the probabilistic ratings determiner(s) 120a and/or 120b may process the estimated population attribute parameters to further estimate numbers of individuals across different demographic classifications who were exposed to given media, numbers of media impressions across different demographic classifications for the given media, accuracy metrics for the estimate number of individuals and/or numbers of media impressions, etc.

FIG. 2 is an example communication flow diagram 200 illustrating an example manner in which the AME 114 and the database proprietor 116 can cooperate to collect demographic impressions based on client devices 102 reporting impressions to the AME 114 and/or the database proprietor 116. FIG. 2 also shows the example probabilistic ratings determiners 120a and 120b, which are able to determine ratings data from population sample data having unreliable demographic classifications in accordance with the teachings of this disclosure. The example chain of events shown in FIG. 2 occurs when a client device 102 accesses media for which the client device 102 reports an impression to the AME 114 and/or the database proprietor 116. In some examples, the client device 102 reports impressions for accessed media based on instructions (e.g., beacon instructions) embedded in the media that instruct the client device 102 (e.g., that instruct a web browser or an app executing on the client device 102) to send beacon/impression requests (e.g., the beacon/impression requests 108 of FIG. 1) to the AME 114 and/or the database proprietor 116. In such examples, the media associated with the beacon instructions is referred to as tagged media. The beacon instructions are machine executable instructions (e.g., code, a script, etc.) which may be contained in the media (e.g., in the HTML of a web page) and/or referenced by the media (e.g., identified by a link in the media that causes the client to request the instructions).

Although the above examples operate based on monitoring instructions associated with media (e.g., a web page, a media file, etc.), in other examples, the client device 102 reports impressions for accessed media based on instructions associated with (e.g., embedded in) apps or web browsers that execute on the client device 102 to send beacon/impression requests (e.g., the beacon/impression requests 108 of FIG. 1) to the AME 114 and/or the database proprietor 116 for media accessed via those apps or web browsers. In such examples, the media itself need not be tagged media. In some examples, the beacon/impression requests (e.g., the beacon/impression requests 108 of FIG. 1) include device/user identifiers (e.g., AME IDs and/or DP IDs) as described further below to allow the corresponding AME 114 and/or the corresponding database proprietor 116 to associate demographic information with resulting logged impressions.

In the illustrated example, the client device 102 accesses tagged media 206 that is tagged with beacon instructions 208. The beacon instructions 208 cause the client device 102 to send a beacon/impression request 212 to an AME impressions collector 218 when the client device 102 accesses the media 206. For example, a web browser and/or app of the client device 102 executes the beacon instructions 208 in the media 206 which instruct the browser and/or app to generate and send the beacon/impression request 212. In the illustrated example, the client device 102 sends the beacon/impression request 212 using an HTTP (hypertext transfer protocol) request addressed to the URL (uniform resource locator) of the AME impressions collector 218 at, for example, a first Internet domain of the AME 114. The beacon/impression request 212 of the illustrated example includes a media identifier 213 identifying the media 206 (e.g., an identifier that can be used to identify content, an advertisement, and/or any other media). In some examples, the beacon/impression request 212 also includes a site identifier (e.g., a URL) of the website that served the media 206 to the client device 102 and/or a host website ID (e.g., www.acme.com) of the website that displays or presents the media 206. In the illustrated example, the beacon/impression request 212 includes a device/user identifier 214. In the illustrated example, the device/user identifier 214 that the client device 102 provides to the AME impressions collector 218 in the beacon impression request 212 is an AME ID because it corresponds to an identifier that the AME 114 uses to identify a panelist corresponding to the client device 102. In other examples, the client device 102 may not send the device/user identifier 214 until the client device 102 receives a request for the same from a server of the AME 114 in response to, for example, the AME impressions collector 218 receiving the beacon/impression request 212.

In some examples, the device/user identifier 214 may be a device identifier (e.g., an international mobile equipment identity (IMEI), a mobile equipment identifier (MEID), a media access control (MAC) address, etc.), a web browser unique identifier (e.g., a cookie), a user identifier (e.g., a user name, a login ID, etc.), an Adobe Flash® client identifier, identification information stored in an HTML5 datastore (where HTML is an abbreviation for hypertext markup language), and/or any other identifier that the AME 114 stores in association with demographic information about users of the client devices 102. In this manner, when the AME 114 receives the device/user identifier 214, the AME 114 can obtain demographic information corresponding to a user of the client device 102 based on the device/user identifier 214 that the AME 114 receives from the client device 102. In some examples, the device/user identifier 214 may be encrypted (e.g., hashed) at the client device 102 so that only an intended final recipient of the device/user identifier 214 can decrypt the hashed identifier 214. For example, if the device/user identifier 214 is a cookie that is set in the client device 102 by the AME 114, the device/user identifier 214 can be hashed so that only the AME 114 can decrypt the device/user identifier 214. If the device/user identifier 214 is an IMEI number, the client device 102 can hash the device/user identifier 214 so that only a wireless carrier (e.g., the database proprietor 116) can decrypt the hashed identifier 214 to recover the IMEI for use in accessing demographic information corresponding to the user of the client device 102. By hashing the device/user identifier 214, an intermediate party (e.g., an intermediate server or entity on the Internet) receiving the beacon request cannot directly identify a user of the client device 102.

In response to receiving the beacon/impression request 212, the AME impressions collector 218 logs an impression for the media 206 by storing the media identifier 213 contained in the beacon/impression request 212. In the illustrated example of FIG. 2, the AME impressions collector 218 also uses the device/user identifier 214 in the beacon/impression request 212 to identify AME panelist demographic information corresponding to a panelist of the client device 102. That is, the device/user identifier 214 matches a user ID of a panelist member (e.g., a panelist corresponding to a panelist profile maintained and/or stored by the AME 114). In this manner, the AME impressions collector 218 can associate the logged impression with demographic information of a panelist corresponding to the client device 102. In some examples, the AME impressions collector 218 determines (e.g., in accordance with the examples disclosed in U.S. Patent Publication No. 2012/0072469 to Perez et al. and/or U.S. patent application Ser. No. 14/604,394 (now U.S. patent Ser. No. ______), etc.) a set of classification probabilities for the panelist to include in the demographic information associated with the logged impression. As described above and in further detail below, the set of classification probabilities represent likelihoods that the panelist belongs to respective ones of a set of possible demographic classifications (e.g., such as likelihoods that the panelist belongs to respective ones of a set of possible age groupings, etc.).

In some examples, the beacon/impression request 212 may not include the device/user identifier 214 (e.g., if the user of the client device 102 is not an AME panelist). In such examples, the AME impressions collector 218 logs impressions regardless of whether the client device 102 provides the device/user identifier 214 in the beacon/impression request 212 (or in response to a request for the identifier 214). When the client device 102 does not provide the device/user identifier 214, the AME impressions collector 218 can still benefit from logging an impression for the media 206 even though it does not have corresponding demographics. For example, the AME 114 may still use the logged impression to generate a total impressions count and/or a frequency of impressions (e.g., a rate of impressions such as impressions per hour) for the media 206. Additionally or alternatively, the AME 114 may obtain demographics information from the database proprietor 116 for the logged impression if the client device 102 corresponds to a subscriber of the database proprietor 116.

In the illustrated example of FIG. 2, to compare or supplement panelist demographics (e.g., for accuracy or completeness) of the AME 114 with demographics from one or more database proprietors (e.g., the database proprietor 116), the AME impressions collector 218 returns a beacon response message 222 (e.g., a first beacon response) to the client device 102 including an HTTP “302 Found” re-direct message and a URL of a participating database proprietor 116 at, for example, a second Internet domain different than the Internet domain of the AME 114. In the illustrated example, the HTTP “302 Found” re-direct message in the beacon response 222 instructs the client device 102 to send a second beacon request 226 to the database proprietor 116. In other examples, instead of using an HTTP “302 Found” re-direct message, redirects may be implemented using, for example, an iframe source instruction (e.g., <iframe src=“ ”>) or any other instruction that can instruct a client device to send a subsequent beacon request (e.g., the second beacon request 226) to a participating database proprietor 116. In the illustrated example, the AME impressions collector 218 determines the database proprietor 116 specified in the beacon response 222 using a rule and/or any other suitable type of selection criteria or process. In some examples, the AME impressions collector 218 determines a particular database proprietor to which to redirect a beacon request based on, for example, empirical data indicative of which database proprietor is most likely to have demographic data for a user corresponding to the device/user identifier 214. In some examples, the beacon instructions 208 include a predefined URL of one or more database proprietors to which the client device 102 should send follow up beacon requests 226. In other examples, the same database proprietor is always identified in the first redirect message (e.g., the beacon response 222).

In the illustrated example of FIG. 2, the beacon/impression request 226 may include a device/user identifier 227 that is a DP ID because it is used by the database proprietor 116 to identify a subscriber of the client device 102 when logging an impression. In some instances (e.g., in which the database proprietor 116 has not yet set a DP ID in the client device 102), the beacon/impression request 226 does not include the device/user identifier 227. In some examples, the DP ID is not sent until the database proprietor 116 requests the same (e.g., in response to the beacon/impression request 226). In some examples, the device/user identifier 227 is a device identifier (e.g., an IMEI), an MEID, a MAC address, etc.), a web browser unique identifier (e.g., a cookie), a user identifier (e.g., a user name, a login ID, etc.), an Adobe Flash® client identifier, identification information stored in an HTML5 datastore, and/or any other identifier that the database proprietor 116 stores in association with demographic information about subscribers corresponding to the client devices 102. In some examples, the device/user identifier 227 may be encrypted (e.g., hashed) at the client device 102 so that only an intended final recipient of the device/user identifier 227 can decrypt the hashed identifier 227. For example, if the device/user identifier 227 is a cookie that is set in the client device 102 by the database proprietor 116, the device/user identifier 227 can be hashed so that only the database proprietor 116 can decrypt the device/user identifier 227. If the device/user identifier 227 is an IMEI number, the client device 102 can hash the device/user identifier 227 so that only a wireless carrier (e.g., the database proprietor 116) can decrypt the hashed identifier 227 to recover the IMEI for use in accessing demographic information corresponding to the user of the client device 102. By hashing the device/user identifier 227, an intermediate party (e.g., an intermediate server or entity on the Internet) receiving the beacon request cannot directly identify a user of the client device 102. For example, if the intended final recipient of the device/user identifier 227 is the database proprietor 116, the AME 114 cannot recover identifier information when the device/user identifier 227 is hashed by the client device 102 for decrypting only by the intended database proprietor 116.

When the database proprietor 116 receives the device/user identifier 227, the database proprietor 116 can obtain demographic information corresponding to a user of the client device 102 based on the device/user identifier 227 that the database proprietor 116 receives from the client device 102. In some examples, the database proprietor 116 determines (e.g., in accordance with the examples disclosed in U.S. Patent Publication No. 2012/0072469 to Perez et al. and/or U.S. patent application Ser. No. 14/604,394 (now U.S. patent Ser. No. ______), etc.) a set of classification probabilities associated with the user of the client device 102 to include in the demographic information associated with this user. As described above and in further detail below, the set of classification probabilities represent likelihoods that the user belongs to respective ones of a set of possible demographic classifications (e.g., likelihoods that the panelist belongs to respective ones of a set of possible age groupings, etc.).

Although only a single database proprietor 116 is shown in FIGS. 1 and 2, the impression reporting/collection process of FIGS. 1 and 2 may be implemented using multiple database proprietors. In some such examples, the beacon instructions 208 cause the client device 102 to send beacon/impression requests 226 to numerous database proprietors. For example, the beacon instructions 208 may cause the client device 102 to send the beacon/impression requests 226 to the numerous database proprietors in parallel or in daisy chain fashion. In some such examples, the beacon instructions 208 cause the client device 102 to stop sending beacon/impression requests 226 to database proprietors once a database proprietor has recognized the client device 102. In other examples, the beacon instructions 208 cause the client device 102 to send beacon/impression requests 226 to database proprietors so that multiple database proprietors can recognize the client device 102 and log a corresponding impression. Thus, in some examples, multiple database proprietors are provided the opportunity to log impressions and provide corresponding demographics information if the user of the client device 102 is a subscriber of services of those database proprietors.

In some examples, prior to sending the beacon response 222 to the client device 102, the AME impressions collector 218 replaces site IDs (e.g., URLs) of media provider(s) that served the media 206 with modified site IDs (e.g., substitute site IDs) which are discernable only by the AME 114 to identify the media provider(s). In some examples, the AME impressions collector 218 may also replace a host website ID (e.g., www.acme.com) with a modified host site ID (e.g., a substitute host site ID) which is discernable only by the AME 114 as corresponding to the host website via which the media 206 is presented. In some examples, the AME impressions collector 218 also replaces the media identifier 213 with a modified media identifier 213 corresponding to the media 206. In this way, the media provider of the media 206, the host website that presents the media 206, and/or the media identifier 213 are obscured from the database proprietor 116, but the database proprietor 116 can still log impressions based on the modified values (e.g., if such modified values are included in the beacon request 226), which can later be deciphered by the AME 114 after the AME 114 receives logged impressions from the database proprietor 116. In some examples, the AME impressions collector 218 does not send site IDs, host site IDS, the media identifier 213 or modified versions thereof in the beacon response 222. In such examples, the client device 102 provides the original, non-modified versions of the media identifier 213, site IDs, host IDs, etc. to the database proprietor 116.

In the illustrated example, the AME impression collector 218 maintains a modified ID mapping table 228 that maps original site IDs with modified (or substitute) site IDs, original host site IDs with modified host site IDs, and/or maps modified media identifiers to the media identifiers such as the media identifier 213 to obfuscate or hide such information from database proprietors such as the database proprietor 116. Also in the illustrated example, the AME impressions collector 218 encrypts all of the information received in the beacon/impression request 212 and the modified information to prevent any intercepting parties from decoding the information. The AME impressions collector 218 of the illustrated example sends the encrypted information in the beacon response 222 to the client device 102 so that the client device 102 can send the encrypted information to the database proprietor 116 in the beacon/impression request 226. In the illustrated example, the AME impressions collector 218 uses an encryption that can be decrypted by the database proprietor 116 site specified in the HTTP “302 Found” re-direct message.

Periodically or aperiodically, the impression data collected by the database proprietor 116 is provided to a DP impressions collector 232 of the AME 114 as, for example, batch data. In some examples, the impression data collected from the database proprietor 116 by the DP impressions collector 232 is demographic impression data, which includes sets of classification probabilities for individuals of a sample population associated with client devices 102 from which beacon requests 226 were received. In some examples, the sets of classification probabilities included in the demographic impression data collected by the DP impressions collector 232 correspond to respective ones of the individuals in the sample population, and may include personal identification capable of identifying the individuals, or may include obfuscated identification information to preserve the anonymity of individuals who are subscribers of the database proprietor but not panelists of the AME 114. In some examples, the sets of classification probabilities included in the demographic impression data collected by the DP impressions collector 232 correspond to aggregated groups of individuals, which also preserves the anonymity of individuals who are subscribers of the database proprietor.

Additional examples that may be used to implement the beacon instruction processes of FIG. 2 are disclosed in U.S. Pat. No. 8,370,489 to Mainak et al. In addition, other examples that may be used to implement such beacon instructions are disclosed in U.S. Pat. No. 6,108,637 to Blumenau.

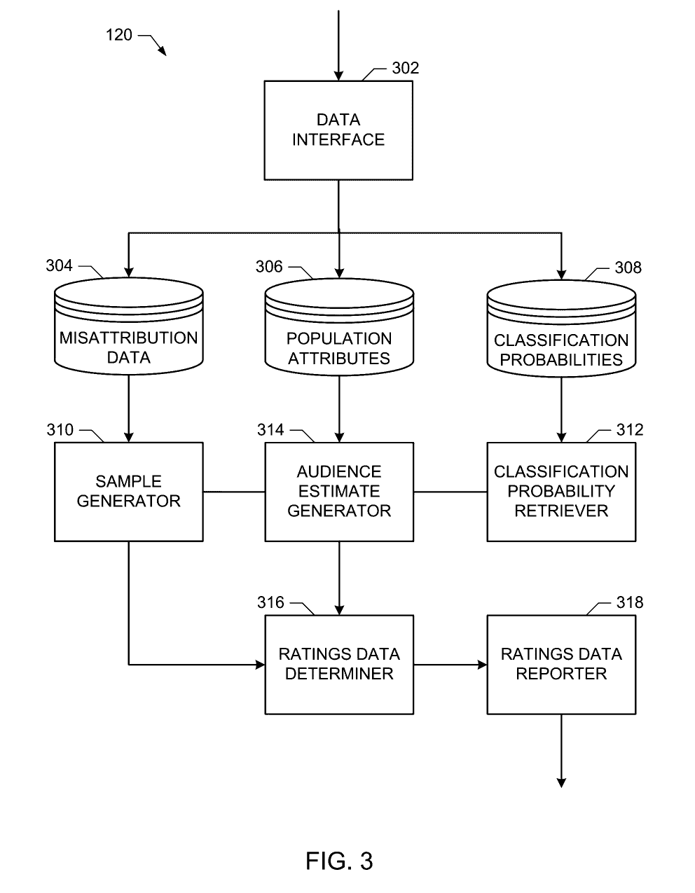

In the example of FIG. 2, the AME 114 includes the example probabilistic ratings determiner 120a to determine ratings data using the sets of classification probabilities determined by the AME impressions collector 218 and/or obtained by the DP impressions collector 232. Additionally or alternatively, in the example of FIG. 2, the database proprietor 116 includes the example probabilistic ratings determiner 120b to determine ratings data using the sets of classification probabilities determined by the database proprietor 116. A block diagram of an example probabilistic ratings determiner 120, which may be used to implement one or both of the example probabilistic ratings determiners 120a and/or 120b, is illustrated in FIG. 3.

FIG. 3 is a block diagram of an example implementation of the probabilistic ratings determiner 120a of FIG. 2. The example probabilistic ratings determiner 120a of FIG. 3 includes a data interface 302, a misattribution data storage 304, a population attributes storage 306, a classification probabilities storage 308, a sample generator 310, a classification probability retriever 312, an audience estimate generator 314, a ratings data determiner 316, and a ratings data reporter 318.

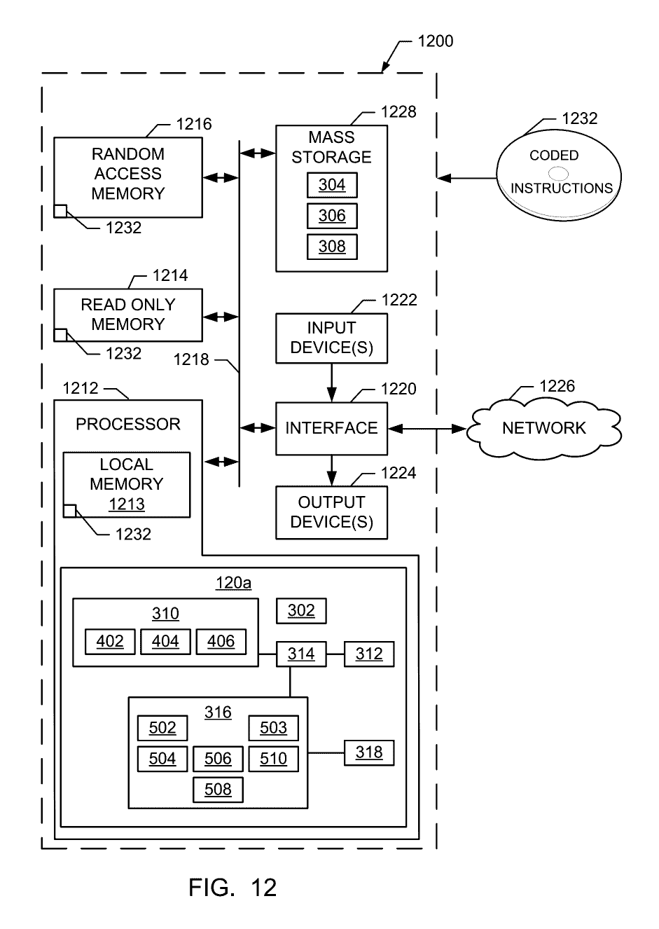

The example data interface 302 of FIG. 3 interfaces with the AME impressions collector 218 and/or the DP impressions collector 232 to obtain, for example, population attributes, such as numbers of impressions for given media, and sets of classification probabilities (also referred to as classification probability distributions) for individuals in a sample population (e.g., such as individuals associated with the devices 102 sending the beacon requests 108, 212, 226, etc.). In some examples, the data interface 302 receives impression requests (e.g., requests indicating a presentation of media at a computing device) from computing devices via a communications network (e.g., the Internet 110 of FIG. 1). Additionally or alternatively, the data interface 302 sends requests for demographic information (e.g., to the database proprietor 116 of FIG. 1) that correspond to the requests received at the data interface 302. The data interface 302 may send the request for demographic information for one or more of the computing devices at a time. The example data interface 302 can be implemented by any type(s), number(s) and/or combination(s) of communication interfaces, network interfaces, etc., such as the example interface circuit 1220 of FIG. 12, which is described in further detail below.

The example misattribution data storage 304 of FIG. 3 stores misattribution information, such as one or more misattribution matrices. Generation of the misattribution matrix stored in the misattribution data storage 304 involves sampling a population and/or a panel, which can involve sampling errors. The example misattribution matrix stored in the misattribution data storage 304 may be obtained via the data interface 302 after being generated. An example of generating the misattribution matrix is described in U.S. patent application Ser. No. 14/752,300. The entirety of U.S. patent application Ser. No. 14/752,300 is incorporated herein by reference.

The example population attributes storage 306 of FIG. 3 stores the population attributes, such as numbers of media impressions, products purchased, services accessed, etc., logged for the different individuals in the sample population. The example classification probabilities storage 308 stores the sets of classifications probabilities obtained via the example data interface 302 for different individuals in the sample population. The example misattribution data storage 304, the example population attributes storage 306, and/or the example classification probabilities storage 308 may be implemented by any number(s) and/or type(s) of volatile and/or non-volatile memory, storage, etc., or combination(s) thereof, such as the example volatile memory 1214 and/or the example mass storage device(s) 1228 of FIG. 12, which is described in further detail below. Furthermore, the example misattribution data storage 304, the example population attributes storage 306, and/or the example classification probabilities storage 308 may be implemented by the same or different volatile and/or non-volatile memory, storage, etc.

The example sample generator 310 of FIG. 3 generates samples of misattribution matrices from a misattribution matrix obtained from the misattribution data storage 304. As mentioned above, generation of the misattribution matrix involves sampling a population and/or a panel, which can involve sampling errors. The example sample generator 310 outputs the samples of the misattribution matrix to correct for sampling errors present in the misattribution matrix.

In the example of FIG. 3, the misattribution matrix represents N demographic groups and includes a number of unique audience members and/or a number of impressions observed during a time period (e.g., requests received from the client devices 102a-102e at the AME 114 of FIG. 1). Thus, the misattribution matrix is an N×N matrix populated with numbers of audience members and/or impressions based on observations of a set of panelists made by the AME 114. An example 2×2 misattribution matrix including unique audience members for a “Young” demographic group and an “Old” demographic group is shown below in Table 1. The misattribution matrix of Table 1 below is a simplified version used for illustration purposes. Misattribution matrices may be implemented for more demographic groups and/or for different divisions of demographic information (e.g., age groups, gender groups, income groups, etc.). Further, the example misattribution matrix of Table 1 below may be extended to any number of demographic groups.

TABLE 1
Misattribution Matrix

| | | Observed | | |
|---|---|---|---|---|
| | | Young | Old | Total |
| Truth | Young | 70 | 30 | 100 |
| | Old | 30 | 170 | 200 |
| | Total | 100 | 200 | 300 |

The columns in Table 1 represent observed audience members (or impressions), which corresponds to the demographic data obtained from the database proprietor 116 of FIGS. 1 and 2 for a set of impression requests. The rows of Table 1 above refer to the truth, as determined from the data set used to generate the matrix. The numbers of audience members in Table 1 are obtained from an example panel, and reflect differences in numbers of observed audience members for different demographic groups (e.g., 100 Young observed and 200 Old observed). The numbers of audience members in Table 1 also reflect the relative distributions within each demographic group to each of the demographic groups in the misattribution matrix (e.g., 70 Young-Young, 30 Young-Old).

As shown in Table 1, the misattribution data storage 304 estimates that 1) 70 audience members have been observed as belonging to the “Young” demographic group and are, in fact, attributable to the “Young” demographic group (e.g., top left element of Table 1), 2) 30 audience members have been observed as belonging to the “Young” demographic group and are attributable to the “Old” demographic group (e.g., bottom left element of Table 1), 3) 30 audience members have been observed as belonging to the “Old” demographic group and are, in truth, attributable to the “Young” demographic group (e.g., top right element of Table 1), and 4) 170 audience members have been observed as belonging to the “Old” demographic group and are attributable to the “Old” demographic group (e.g., bottom right element of Table 1).

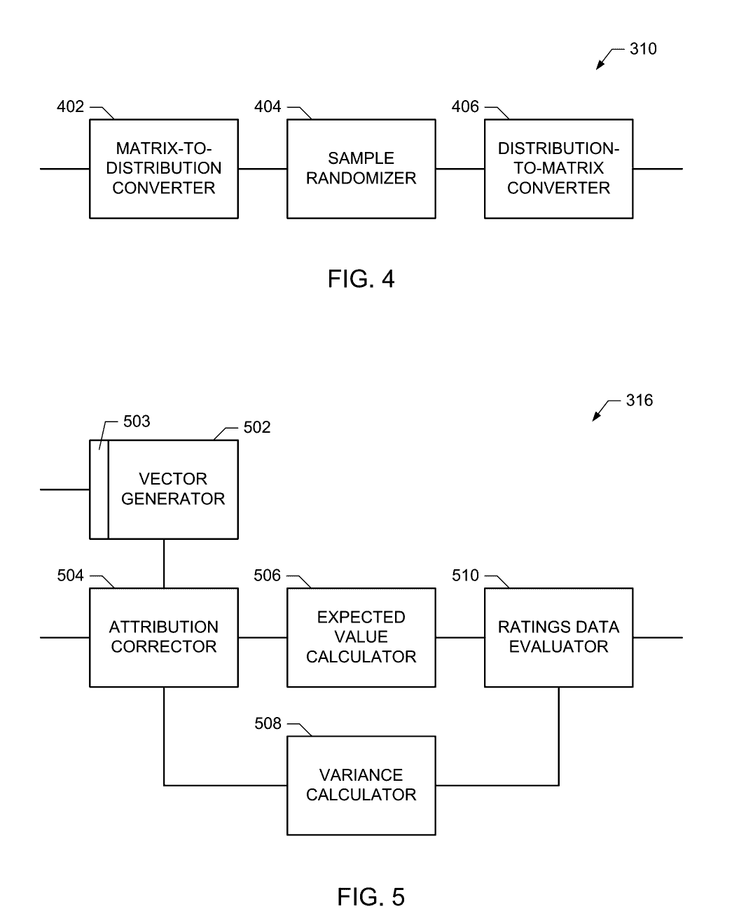

To correct for the sampling errors in the misattribution matrix, the example sample generator 310 uses Monte Carlo methods (e.g., repeated random sampling) based on the misattribution matrix. Monte Carlo methods enable simulation of large numbers of misattributions from the misattribution matrix that has an inherent uncertainty (e.g., due to sampling errors). FIG. 4 is a block diagram of an example implementation of the sample generator 310 of FIG. 3.

The example sample generator 310 of FIG. 4 includes a matrix-to-distribution converter 402, a sample randomizer 404, and a distribution-to-matrix converter 406. The example matrix-to-distribution converter 402 generates a multinomial distribution from the misattribution matrix. For example, the matrix-to-distribution converter 402 may convert the misattribution matrix of Table 1 above to a multinomial distribution p as shown in Equation 1 below:

$$p = [ \frac{70}{300} , \frac{30}{300} , \frac{30}{300} , \frac{170}{300} ] \qquad Equation 1$$

The elements of Equation 1 represent the likelihoods that an audience member will fall into the Observed-Actual buckets of the misattribution matrix. The example sample randomizer 404 of FIG. 4 generates one or more samples from the multinomial distribution. For example, to generate a sample, the sample randomizer 404 may execute a number of trials to determine respective numbers of audience members for each element of the misattribution matrix. In the example of FIG. 4, the sample randomizer 404 conducts a trial by simulating a random selection from a group of audience members having selection probabilities according to the multinomial distribution (e.g., the selection probabilities shown in Equation 1). For example, the sample randomizer 404 performs a first trial where the possible outcomes of the randomly selected audience member are (Observed-Actual) Young-Young, Young-Old, Old-Young, or Young-Old, and the trial must result in one of the outcomes. The number of trials may be selected to be equal to the total number of audience members used to generate the misattribution matrix (e.g., 300 audience members and 300 trials, in the example misattribution matrix of Table 1). However, any number of trials may be performed to generate each sample, and/or different numbers of trials may be used for different ones of the samples.

Continuing with the example, the sample randomizer 404 of FIG. 4 repeats the trials until 300 trials have been performed, and records the results of the 300 trials as one sample distribution. Table 2 illustrates a set of 10 sample distributions generated from 300 trials each of the misattribution matrix. For example, in Table 2, sample 1 is obtained by simulating 300 independent selections from the multinomial distribution of Equation 1 above, resulting in 76 selections of the Young-Young category, 30 selections of the Young-Old category, 20 selections of the Old-Young category, and 174 selections of the Old-Old category. In some examples, a large number of sample misattribution matrices (e.g., 1,000 samples or more) may be generated.

TABLE 2
Example Sample Distributions from Multinomial Distribution

| Sample | Y-Y | Y-O | O-Y | O-O | Total |
|---|---|---|---|---|---|
| 1 | 76 | 30 | 20 | 174 | 300 |
| 2 | 57 | 26 | 38 | 179 | 300 |
| 3 | 71 | 30 | 29 | 170 | 300 |
| 4 | 67 | 31 | 24 | 178 | 300 |
| 5 | 68 | 29 | 22 | 181 | 300 |
| 6 | 73 | 34 | 29 | 164 | 300 |
| 7 | 58 | 24 | 37 | 181 | 300 |
| 8 | 63 | 24 | 38 | 175 | 300 |
| 9 | 75 | 28 | 43 | 154 | 300 |
| 10 | 74 | 37 | 29 | 160 | 300 |

The example distribution-to-matrix converter 406 of FIG. 4 converts the samples to corresponding misattribution matrices. Table 3 below illustrates an example misattribution matrix resulting from sample 10 (e.g., the bottom row of Table 2 above).

TABLE 3
Misattribution Matrix converted from sample 10 of Table 2

| | | Observed | | |
|---|---|---|---|---|
| | | Young | Old | Total |
| Tru | Young | 74 | 29 | 103 |
| | Old | 37 | 260 | 197 |
| | Total | 111 | 289 | 300 |

The example misattribution matrices obtained by converting the samples generated by the sample randomizer 404 may then be used to adjust numbers of audience members and/or impressions, as described in more detail below.

Returning to FIG. 3, the example classification probability retriever 312 accesses sets of classification probabilities stored in the classification probabilities storage 308 for respective individuals in a sample population exposed to media. As described above, a given set of classification probabilities represents likelihoods that a given individual in the sample population belongs to respective ones of a set of possible demographic groups or demographic classifications. The terms “demographic group” and “demographic classification” are used interchangeably herein. An example implementation of the classification probability retriever 312 is described in U.S. patent application Ser. No. 14/752,300. The entirety of U.S. patent application Ser. No. 14/752,300 in incorporated herein by reference. The example classification probabilities may be used as sets of audience members and/or impressions for demographic groups that are to be corrected via the misattribution matrices.

The audience estimate generator 314 of FIG. 3 estimates parameters characterizing population attributes that are based on sums of individual attributes within respective ones of the different possible demographic classifications. The example audience estimate generator 314 outputs expected values (which may be mean values or average values) of audience members and/or impressions, the variance values of the expected values, and covariance values for pairs of the expected values. For example, the population attribute parameters estimated by the example audience estimate generator 314 of FIG. 3 may be parameters of (1) a model which characterizes numbers (e.g., sums) of individuals associated with respective ones of the set of possible demographic classifications (e.g., such as numbers of individuals associated with respective demographic buckets in a set of possible demographic buckets, etc.), (2) a model which characterizes numbers (e.g., sums) of media impressions associated with the respective ones of the set of possible demographic classifications (e.g., such as numbers of media impressions associated with the respective demographic buckets in the set of possible demographic buckets, etc.), etc. An example implementation of the audience estimate generator 314 is described in U.S. patent application Ser. No. 14/752,300.

Example expected values E[X] (e.g., expected audience members E[U], expected impressions E[I], etc.), and the variance values and covariance values σ(XᵢXⱼ) of the expected values E[X], that may be output by the audience estimate generator 314 for four demographic groups are shown in example Equations 2 and 3 below. The example of Equation 2 is obtained from sample data in which 10,000 unique audience members were recorded during an example time period for a first item of media. Equation 3 illustrates variances (e.g., the positive numbers on the diagonals) and covariances (e.g., the negative numbers not on the diagonals) for the demographic groups in the expected audience members.

$$\begin{matrix}E [ U ] = ( 4 , 184 \; 2 , 996 \; 1 , 903 \; 917 ) & Equation 2 \\ σ ( UiUj ) = ( \begin{matrix}2 , 348 & - 1 , 241 & - 755 & - 352 \\ - 1 , 241 & 2 , 066 & - 536 & - 262 \\ - 755 & - 563 & 1 , 503 & - 185 \\ - 352 & - 262 & - 185 & 798\end{matrix} ) & Equation 3\end{matrix}$$

In Equation 2, 4,184 persons of the 10,000 observed persons are expected to be in the first demographic group (e.g., age and gender group). The calculated variance of the first demographic group is 2,348. The example audience estimate generator 314 provides the expected values E[X], the variance values, and/or the covariance values to the example ratings data determiner 316.

The example ratings data determiner 316 of FIG. 3 applies numbers of audience members and/or impressions to the misattribution matrices to determine corrected numbers of audience members and/or impressions for each of the demographic groups represented in the misattribution matrices.

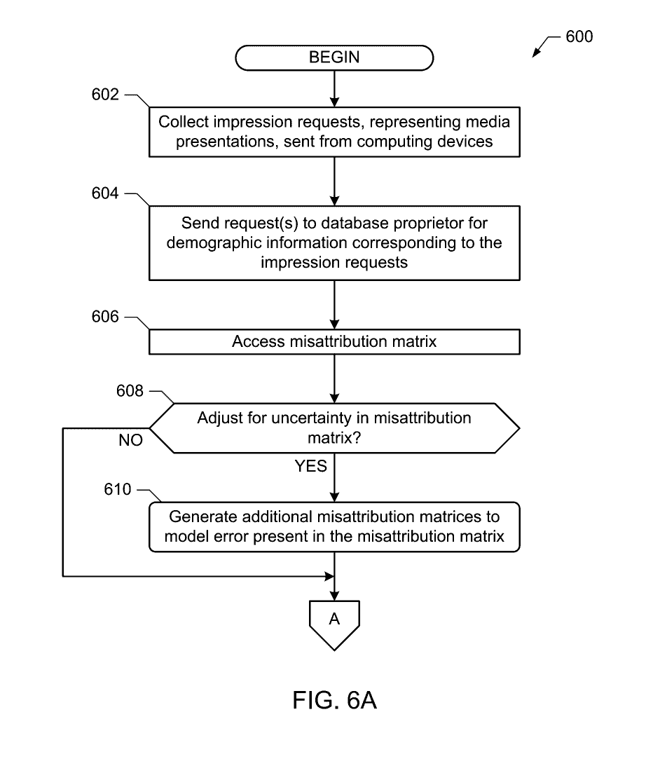

FIG. 5 is a block diagram of an example implementation of the ratings data determiner 316 of FIG. 3. The example ratings data determiner 316 of FIG. 5 includes a vector generator 502, an attribution corrector 504, an expected value calculator 506, a variance calculator 508, and a ratings data evaluator 510.

The example vector generator 502 of FIG. 5 receives the expected audience values via a data interface 503 with the audience estimate generator 314. The example vector generator 502 determines a number of misattribution matrices obtained from the sample generator 310 (e.g., via Monte Carlo simulations). In some examples, the example vector generator 502 generates a same number of audience member and/or impression vectors from the average number of audience members and/or impressions. For example, the vector generator 502 may pseudorandomly generate vectors based on expected values of unique audience members, variance values, and/or covariance values, which are obtained as described in U.S. patent application Ser. No. 14/752,300.

In some other examples, the vector generator 502 generates one vector, including the expected numbers (e.g., mean number) of audience members and/or impressions for each of the demographic groups. In the case in which the vector generator 502 generates one vector, the one generated vector is to be separately applied to each of the misattribution matrices (as described in more detail below).

The example attribution corrector 504 of FIG. 5 applies the numbers of audience members in the vector(s) (e.g., observed numbers of audience members in each demographic group) to the misattribution matrices. For example, the attribution corrector 504 may apply the vector(s) to the misattribution matrices by performing respective matrix multiplication(s) of the numbers of audience members in a vector (a first matrix) and corresponding misattribution matrices (a second matrix). In some examples (e.g., Example 1 below), the attribution corrector 504 applies a same vector of expected values, output by the audience estimate generator 314, to the misattribution matrices generated by the sample generator 310. In some other examples (e.g., Example 2 below), the attribution corrector 504 applies different vectors to corresponding ones of multiple misattribution matrices. In still other examples, (e.g., Example 3 below), the attribution corrector 504 uses one misattribution matrix to correct the vector of expected values and/or the covariance values of the vector. While Examples 1-3 below are described with reference to audience members, the examples may additionally or alternatively be applied to numbers of impressions.

### Example 1

In a first example of attribution correction, the attribution corrector 504 of FIG. 5 applies a same vector of expected numbers of audience members for the demographic groups to each of the misattribution matrices generated by the sample generator 310 of FIG. 3. The results of applying the expected numbers of audience members to the misattribution matrices are sets of corrected values. The sets of corrected values may then be averaged or otherwise processed to obtain an estimated number of audience members for each of the demographic groups.

Using the Young-Old example from above, assume that 60 unique audience members are observed to be in the “Young” demographic group and 40 unique audience members are observed to be in the “Old” demographic group during a media campaign. The observed numbers of unique audience members in the “Young” and “Old” demographic groups are based on demographic information provided by the database proprietor 116, and do not necessarily reflect the truth.

The example attribution corrector 504 constructs a vector, or N×1 matrix, based on the structure of misattribution matrix to which the vector is to be applied. For example, the attribution corrector 504 of FIG. 5 generates the vector so that the audience members observed to be in the “Young” demographic group are correctly multiplied with the elements of the misattribution matrix that correspond to Young observed (e.g., the first column of FIG. 3 above), and so that the audience members observed to be in the “Old” demographic group are correctly multiplied with the elements of the misattribution matrix that correspond to Old observed (e.g., the second column of FIG. 3 above). Thus, in this example the attribution corrector 504 generates the vector (e.g., a 2×1 matrix) to be (60, 40).

The example attribution corrector 504 applies the vector (60, 40) to each of the misattribution matrices obtained from the sample generator 310. To apply the numbers of audience members to the misattribution matrices, the example attribution corrector 504 multiplies, for each demographic group: 1) the number of audience members observed for a selected demographic group (e.g., the Young number in the vector), by 2) the fraction or percentage of the number of audience members observed to be in the selected demographic group that are attributable to a demographic group under consideration (e.g., the Young-Young element of the misattribution matrix divided by the total of the Observed Young column, and the Young-Old element of the misattribution matrix divided by the total of the Observed Young column). For each demographic group, the attribution corrector 504 then sums the numbers of audience members that were adjusted by the multiplications.

As an example, applying the numbers of audience members in the example vector (60, 40) to the example misattribution matrix of Table 1 above would result in corrected numbers of audience members for the Young and Old demographics (e.g., Young_{adjusted} and Old_{adjusted}) as calculated in Equations 4 and 5 below.

$$\begin{matrix}\begin{matrix}{Young}_{adjusted} = ( Young \text{-} Young / Total Observed {Young }^{*} \\ Vector Young ) + ( Old \text{-} Young / Total \\ Observed {Old }^{*} Vector Old ) \\ = ( 70 / {100 }^{*} 60 ) + ( 30 / {200 }^{*} 40 ) = 42 + 6 = 48\end{matrix} & Equation 4 \\ \begin{matrix}{Old}_{adjusted} = ( Young \text{-} Old / Total Observed {Young }^{*} \\ Vector Young ) + ( Old \text{-} Old / Total \\ Observed {Old }^{*} Vector Old ) \\ = ( 30 / {100 }^{*} 60 ) + ( 170 / {200 }^{*} 40 ) = 18 + 34 = 52\end{matrix} & Equation 5\end{matrix}$$

In Equations 4 and 5 above, the notation (X-X) is not a subtraction, but refers to Observed-Actual as used in Table 1 above (e.g., Young-Young is the upper left square, corresponding to Young Observed and Young Actual; Young-Old is the lower left square, corresponding to Young Observed and Old Actual, etc.). The example attribute corrector 504 outputs the corrected numbers of audience members, such as in vector form, to the example expected value calculator 506 and/or to the example variance calculator 508.

### Example 2

In other examples, the attribution corrector 504 applies different vectors (e.g., combinations of numbers of audience members) to different ones of the sample misattribution matrices generated by the sample generator 310. The vectors and the sample misattribution matrices of this example are generated and matched at a 1:1 ratio. By generating multiple vectors and multiple misattribution matrices, these examples correct for errors resulting from probabilistic assignments of audience members to demographic groups and for errors resulting from randomness (e.g., noise) in the process of generating the misattribution matrix (e.g., error in the multinomial distributions). While this example refers to applying different vectors, one or more vectors generated by the vector generator 502 may have identical values due to the process of pseudorandomly generating large numbers of vectors from the expected values, the variance values, and/or the covariance values obtained from the audience estimate generator 314, which is discussed below.

For example, the vector generator 502 may have generated a vector corresponding to each sample misattribution matrix (e.g., 10 vectors corresponding to the 10 misattribution matrices from Table 2 above). For example, the audience estimate generator 314 of FIG. 3 may output expected values of E[Uᵢ]=(60, 40) and variance and covariance values of

$$σ ( UiUj ) = ( \begin{matrix}24 & - 24 \\ - 24 & 24\end{matrix} ) .$$

Table 4 below illustrates example vectors that are pseudorandomly generated for corresponding ones of the misattribution matrices of Table 2 above based on the expected values E[Uᵢ], and the resulting corrected expected values calculated by the attribution corrector 504.

TABLE 4
Example Misattribution Matrices with corresponding expected
values and resulting corrected expected values

| Sample | Y-Y | Y-O | O-Y | O-O | Y | O | Yₐ | Oₐ |
|---|---|---|---|---|---|---|---|---|
| 1 | 76 | 30 | 20 | 174 | 61 | 39 | 48 | 52 |
| 2 | 57 | 26 | 38 | 179 | 64 | 36 | 50 | 50 |
| 3 | 71 | 30 | 29 | 170 | 64 | 36 | 50 | 50 |
| 4 | 67 | 31 | 24 | 178 | 61 | 39 | 46 | 54 |
| 5 | 68 | 29 | 22 | 181 | 50 | 50 | 40 | 60 |
| 6 | 73 | 34 | 29 | 164 | 68 | 32 | 51 | 49 |
| 7 | 58 | 24 | 37 | 181 | 60 | 40 | 49 | 51 |
| 8 | 63 | 24 | 38 | 175 | 63 | 37 | 52 | 48 |
| 9 | 75 | 28 | 43 | 154 | 59 | 41 | 52 | 48 |
| 10 | 74 | 37 | 29 | 160 | 60 | 40 | 46 | 54 |

In Table 4 above, the Y-Y, Y-O, O-Y, and O-O columns represent the misattribution matrix values (e.g., after conversion to the misattribution matrices by the distribution-to-matrix converter 406 of FIG. 4). The Y column in Table 4 represents the number of audience members in the Young demographic group in the corresponding pseudorandomly generated expected value vector, and the O column represents the number of audience members in the Old demographic group in the corresponding pseudorandomly generated expected value vector. The Yₐ column in Table 4 represents the corrected number of audience members in the Young demographic group and the Oₐ column represents the corrected (e.g., adjusted) number of audience members in the Old demographic group.

The example attribution corrector 504 outputs the corrected numbers of audience members (e.g., in vector form (Yₐ, Oₐ)) to the example expected value calculator 506 and/or to the example variance calculator 508. As shown in Table 4, when applying the vectors to the misattribution matrices, the example attribution corrector 504 ensures that the sums of the output adjusted numbers of audience members (e.g., Yₐ+Oₐ) are equal to the sums of the input observed numbers of audience members (e.g., Y+O).

The example expected value calculator 506 generates an expected value from the one or more corrected vectors. For example, the expected value calculator 506 may average corresponding elements in the vectors (e.g., all of the elements corresponding to the Young demographic group, all of the elements corresponding to the Old demographic group, etc.). The resulting vector represents the estimated number of audience members in each demographic group for the campaign in which the audience members were observed (e.g., the demographic group into which the audience members were identified by the database proprietor 116 in response to one or more requests corresponding to impression(s) of media).

The example variance calculator 508 calculates variance values and/or covariance values from the corrected vectors. For example, the variance calculator 508 may calculate a covariance matrix that includes both the variance values and the covariance values. The variance values and/or the covariance values provide a measure of the statistical certainty in the expected values generated by the expected value calculator 506. Thus, the variance values and/or the covariance values may aid in statistical analyses of campaign impressions and/or audience members by, for example, providing a measurement (e.g., a range) of confidence in the result.

The example ratings data evaluator 510 of FIG. 5 uses the expected or average values determined by the example expected value calculator 506 to determine the ratings data for the respective ones and/or combinations of the possible demographic classifications. The example ratings data evaluator 510 may additionally or alternatively generate and output statistical analyses of the expected values based on the variance values and/or covariance values determined by the variance calculator 508.

### Example 3

In some other examples, the attribution corrector 504 of FIG. 5 applies an expected vector E[X] and a corresponding covariance matrix σ(XᵢXⱼ) to a fixed misattribution matrix (e.g., obtained from the misattribution data storage 304). As used with reference to a misattribution matrix or a vector, the term “fixed” refers to being considered without error and/or without randomness (e.g., deterministic, if the misattribution matrix or the vector is believed to be substantially error-free). In Example 3, the expected vector E[X] is applied to a same fixed misattribution matrix rather than multiple, non-fixed (e.g., random) misattribution matrices as in Example 1.

The example expected vector E[X] and the corresponding covariance σ(XᵢXⱼ) may be generated as described above in Example 2. In such examples, the attribution corrector 504 (and/or the expected value calculator 506 and the variance calculator 508) may calculate the corrected expected values and the corrected covariance matrix using Equations 6 and 7 below. In Equation 6, μ is the expected value in the vector E[X], is the covariance, R is a misattribution matrix that has been normalized such that each column sums to 100%, and T is the transverse operator.

μ′=μ·R^{T} Equation 6

Σ′=RΣR^{T} Equation 7

By calculating Equations 6 and 7, the example attribution corrector 504 corrects for probabilistic demographic bucket assignments, as well as random (but fixed) misattribution. For example, Equations 6 and 7 apply the misattribution matrix to a distribution of all defined age buckets (e.g., the expected values of the age buckets, a covariance matrix of the age buckets including the variances of the age buckets and the covariances between age buckets). The expected value describes the probability assigned to each age bucket (e.g., an average), and the covariance matrix describes both (1) the concentrations of those probabilities near the expected value, and (2) how the age buckets relate to each other. Each defined age bucket is applied to the misattribution matrix. Thus, Equations 6 and 7 describe an analytical solution for a hypothetical situation in which there are infinitely many simulations of: 1) generating a random vector using the expected vector E[X] and the corresponding covariance σ(XᵢXⱼ) and b) applying the generated random vector to the misattribution matrix, where each of the simulations independently generates a random vector. Equations 6 and 7 output expected values and a covariance matrix for the age buckets based on correction using the misattribution matrix.

By applying each vector to the corresponding misattribution matrix (e.g., in the same manner as described above in Example 1), the attribution corrector 504 generates a set of corrected vectors.

The example ratings data evaluator 510 of FIG. 5 uses the expected or average values determined by the example expected value calculator 506 to determine the ratings data for the respective ones and/or combinations of the possible demographic classifications. The example ratings data evaluator 510 may additionally or alternatively generate and output statistical analyses of the expected values based on the variance values and/or covariance values determined by the variance calculator 508. Table 5 below illustrates an example of ratings data that may be generated by the ratings data evaluator 510.

TABLE 5
Example Ratings Data

| | Young | Old | Total |
|---|---|---|---|
| Unique | 47.9 | 52.1 | 100 |
| Audience | | | |

Covariance

| Young | Old |
|---|---|
| 8.41 | −8.41 |
| −8.41 | 8.41 |

The example ratings data of Table 5 above includes the corrected values of the Young and Old unique audience (e.g., the estimated number of audience members), and the variance and covariance values of the corrected values (e.g., measures of confidence in the estimate). Similar ratings data may be generated for impressions, using impressions attributed to the demographic groups instead of unique audience members.

Returning to FIG. 3, the example ratings data reporter 318 transmits the ratings data determined by the example ratings data determiner 316 to one or more recipients. For example, the ratings data reporter 318 can be configured to transmit the ratings data electronically to a media provider that provided the media corresponding to the media impressions logged for an online media ratings campaign. In some examples, the ratings data reporter 318 reports the ratings data periodically, aperiodically, based on occurrence of an event (e.g., receipt of a request for ratings data, when a storage buffer becomes full, etc.), etc.

While an example manner of implementing the probabilistic ratings determiner 120a of FIG. 2 is illustrated in FIGS. 3, 4, and 5, one or more of the elements, processes and/or devices illustrated in FIGS. 3, 4, and 5 may be combined, divided, re-arranged, omitted, eliminated and/or implemented in any other way. Further, the example data interface 302, the example misattribution data storage 304, the example population attributes storage 306, the example classification probabilities storage 308, the example sample generator 310, the example classification probability retriever 312, the example audience estimate generator 314, the example ratings data determiner 316, the example ratings data reporter 318, the example matrix-to-distribution converter 402, the example sample randomizer 404, the example distribution-to-matrix converter 406, the example vector generator 502, the example attribution corrector 504, the example expected value calculator 506, the example variance calculator 508, the example ratings data evaluator 510 and/or, more generally, the example probabilistic ratings determiner 120a of FIG. 2 may be implemented by hardware, software, firmware and/or any combination of hardware, software and/or firmware. Thus, for example, any of the example data interface 302, the example misattribution data storage 304, the example population attributes storage 306, the example classification probabilities storage 308, the example sample generator 310, the example classification probability retriever 312, the example audience estimate generator 314, the example ratings data determiner 316, the example ratings data reporter 318, the example matrix-to-distribution converter 402, the example sample randomizer 404, the example distribution-to-matrix converter 406, the example vector generator 502, the example attribution corrector 504, the example expected value calculator 506, the example variance calculator 508, the example ratings data evaluator 510 and/or, more generally, the example probabilistic ratings determiner 120a could be implemented by one or more analog or digital circuit(s), logic circuits, programmable processor(s), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example data interface 302, the example misattribution data storage 304, the example population attributes storage 306, the example classification probabilities storage 308, the example sample generator 310, the example classification probability retriever 312, the example audience estimate generator 314, the example ratings data determiner 316, the example ratings data reporter 318, the example matrix-to-distribution converter 402, the example sample randomizer 404, the example distribution-to-matrix converter 406, the example vector generator 502, the example attribution corrector 504, the example expected value calculator 506, the example variance calculator 508, and/or the example ratings data evaluator 510 is/are hereby expressly defined to include a tangible computer readable storage device or storage disk such as a memory, a digital versatile disk (DVD), a compact disk (CD), a Blu-ray disk, etc. storing the software and/or firmware. Further still, the example probabilistic ratings determiner 120a of FIG. 2 may include one or more elements, processes and/or devices in addition to, or instead of, those illustrated in FIGS. 2, 3, 4, and/or 5 and/or may include more than one of any or all of the illustrated elements, processes and devices.

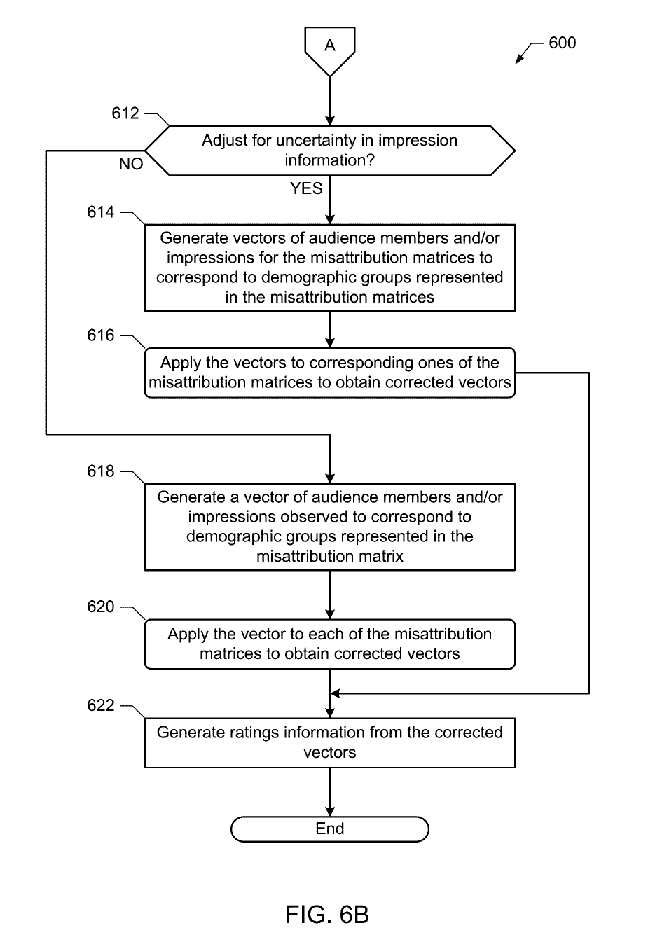

Flowcharts representative of example machine readable instructions for implementing the probabilistic ratings determiner 120a of FIG. 2 are shown in FIGS. 6A-6B, 7, and 8. In this example, the machine readable instructions comprise program(s) for execution by a processor such as the processor 1212 shown in the example processor platform 1200 discussed below in connection with FIG. 12. The program(s) may be embodied in software stored on a tangible computer readable storage medium such as a CD-ROM, a floppy disk, a hard drive, a digital versatile disk (DVD), a Blu-ray disk, or a memory associated with the processor 1212, but the entire program(s) and/or parts thereof could alternatively be executed by a device other than the processor 1212 and/or embodied in firmware or dedicated hardware. Further, although the example program(s) are described with reference to the flowcharts illustrated in FIGS., many other methods of implementing the example probabilistic ratings determiner 120a may alternatively be used. For example, the order of execution of the blocks may be changed, and/or some of the blocks described may be changed, eliminated, or combined.

As mentioned above, the example processes of FIGS. 6A-6B, 7, and 8 may be implemented using coded instructions (e.g., computer and/or machine readable instructions) stored on a tangible computer readable storage medium such as a hard disk drive, a flash memory, a read-only memory (ROM), a compact disk (CD), a digital versatile disk (DVD), a cache, a random-access memory (RAM) and/or any other storage device or storage disk in which information is stored for any duration (e.g., for extended time periods, permanently, for brief instances, for temporarily buffering, and/or for caching of the information). As used herein, the term tangible computer readable storage medium is expressly defined to include any type of computer readable storage device and/or storage disk and to exclude propagating signals and transmission media. As used herein, “tangible computer readable storage medium” and “tangible machine readable storage medium” are used interchangeably. Additionally or alternatively, the example processes of FIGS. 6A-6B, 7, and 8 may be implemented using coded instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and transmission media. As used herein, when the phrase “at least” is used as the transition term in a preamble of a claim, it is open-ended in the same manner as the term “comprising” is open ended.

FIGS. 6A and 6B illustrate a flowchart representative of example machine readable instructions 600 that may be executed to implement the example probabilistic ratings determiner 120a of FIGS. 2 and/or 3 to determine ratings data. The instructions 600 may be executed, for example, when a set of requests has been received from client devices, and impression information (e.g., unique audience counts, impression counts) is to be attributed to demographic groups.

The example data interface 302 of FIG. 3 collects impression requests from client devices (e.g., the client device 102 of FIG. 2), where the impression requests represent media presentations (block 602). For example, the data interface 302 may receive impression requests 212 from the AME impressions collector 218 of FIG. 2. The impression requests 212 may identify the media being presented (e.g., the media identifier 213) and provide an identifier of the client device 102 (e.g., the device/user identifier 214).

The example data interface 302 sends request(s) to a database proprietor (e.g., the database proprietor 116 of FIG. 2) for demographic information corresponding to the impression requests (block 604). In some examples, the data interface 302 responds to impression requests with a redirect message 222 to cause the client device to send a request (e.g., the impression request 226) to the database proprietor 116. In some other examples, the data interface 302 requests demographic information for a set of collected device/user identifiers 214 via an out-of-band channel.

The example sample generator 310 accesses a misattribution matrix (block 606). The misattribution matrix may be stored in the misattribution data storage 304 by the data interface 302, based on receiving the misattribution matrix from an entity that calculated the misattribution matrix (e.g., based on a population survey).

The example sample generator 310 determines whether to adjust for uncertainty in the misattribution matrix (block 608). For example the sample generator 310 may be instructed whether to adjust for uncertainty in the misattribution matrix, may adjust for uncertainty by default, or may adjust for uncertainty based on one or more properties of the misattribution matrix (e.g., adjust for uncertainty when less than a threshold sample size used to generate the misattribution matrix).

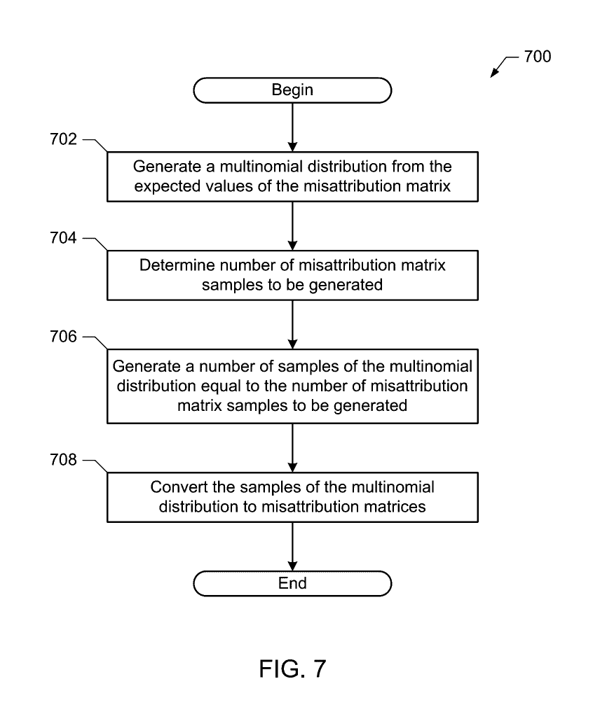

When the sample generator 310 is to adjust for uncertainty in the misattribution matrix (block 608), the example sample generator 310 generates additional misattribution matrices to model error present in the misattribution matrix (block 610). For example, the sample generator 310 may execute a number of trials using Monte Carlo methods, which results in a set of misattribution matrices randomly generated using the properties of the first misattribution matrix. Example instructions to implement block 610 are described below with reference to FIG. 7.

After generating the additional misattribution matrices (block 610), or Turning to FIG. 6B, the example ratings data determiner 316 (e.g., via the vector generator 502 of FIG. 5) determines whether to correct for uncertainty in the impression information (block 612). For example, there is a randomness in assigning people to certain demographic groups, and some uncertainty (e.g., represented by the covariance matrix.

If the vector generator 502 is to correct for uncertainty in the impression information (block 612), the example vector generator 502 generates vectors of audience members and/or impression for the misattribution matrices to correspond to the demographic groups represented in the misattribution matrix (block 614). For example, the vector generator 502 may use an expected number of audience members and/or impressions determined by probabilistic assignment of audience members and/or impressions to demographic groups, as described in U.S. patent application Ser. No. 14/752,300 (incorporated herein by reference). The example vector generator 502 may further use the variance values and/or covariance values corresponding to the expected values.

In some other examples, the vector generator 502 performs trials based on the probabilistically determined expected values, variance values, and/or covariance values, to obtain random samples of audience members and/or impressions to apply to the same number of misattribution matrices generated by the sample generator 310.

After generating the vectors of the audience members and/or impressions, the example attribution corrector 504 applies the vectors to corresponding ones of the misattribution matrices to obtain corrected vectors (block 616). For example, the attribution corrector 504 may apply the generated vectors to the misattribution matrix from the misattribution data storage 304 or to the misattribution matrices generated by the sample generator 310.

If the vector generator 502 is not to correct for uncertainty in the impression information (block 612), the example vector generator 502 generates a vector of audience members and/or impressions observed to correspond to the demographic groups represented in the misattribution matrix (block 618). For example, the vector generator 502 may generate a vector of audience members and/or impressions including the number of audience members and/or impressions probabilistically attributed to each demographic group.

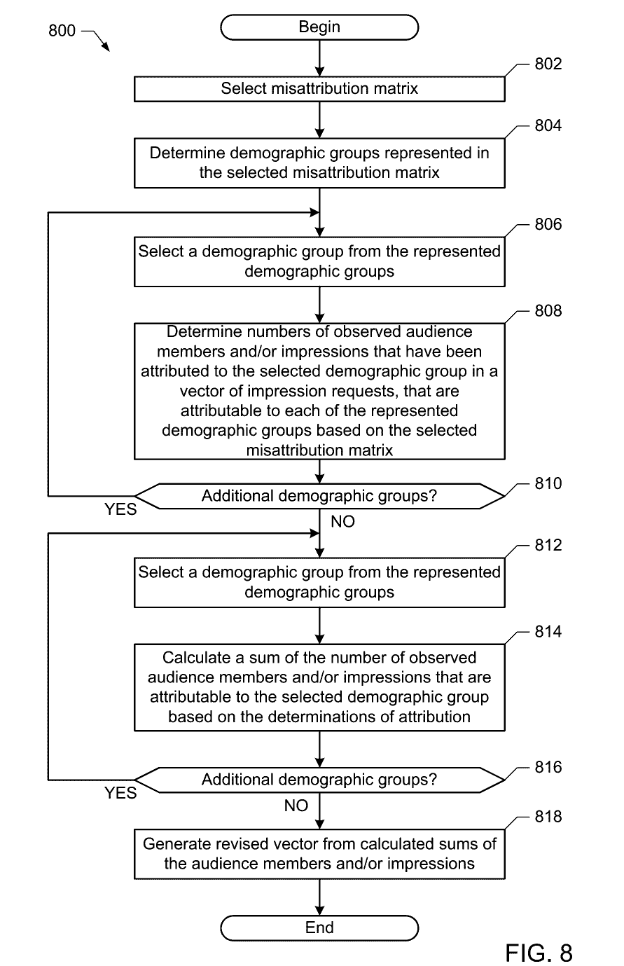

The example attribution corrector 504 applies the vector to each of the misattribution matrices to obtain corrected vectors (block 620). For example, the attribution corrector 504 may apply the vector to the misattribution matrix from the misattribution data storage 304 or to the misattribution matrices generated by the sample generator 310. In some examples, applying the vector to the misattribution matrix includes performing matrix multiplication of a 1×N vector with an N×N misattribution matrix (or the N×N misattribution matrix with an N×1 vector). The result of the matrix multiplication is a vector of the same size as the applied vector, including corrected numbers of audience members or impressions. Example instructions to implement blocks 616 and/or 620 are described below with reference to FIG. 8.

After applying the vector(s) to the misattribution matrices (block 616 or block 620), the example ratings data evaluator 510 generates ratings information from the corrected vectors (block 622). Example ratings information may include numbers of audience members in each demographic group that were presented with media of interest and numbers of impressions of the media of interest for each of the demographic groups. Additionally or alternatively, the example ratings data evaluator 510 may perform one or more statistical analyses on the corrected vectors, such as identifying correlated demographic groups and/or confidence intervals for the data.

The example instructions 600 of FIGS. 6A-6B may then end and/or iterate for additional impression information.

FIG. 7 is a flowchart representative of example machine readable instructions 700 that may be executed to implement the sample generator 310 of FIGS. 3 and 4 to generate samples of a misattribution matrix. The example instructions 700 may be executed by request from a calling function, such as block 610 of FIG. 6A.

The example matrix-to-distribution converter 402 of FIG. 4 generates a multinomial distribution from the expected values of the misattribution matrix (block 702). For example, the matrix-to-distribution converter 402 may convert the expected values from each element in the misattribution matrix to a probability that a randomly selected person in a population will fall into the corresponding Observed-Actual element or relationship. For example, the misattribution matrix of Table 1 above may be converted to the multinomial distribution of Equation 1 above.

The example sample randomizer 404 of FIG. 4 determines a number of misattribution matrix samples to be generated (block 704). For example, the sample randomizer 404 may determine that a minimum number of misattribution matrices are to be generated to obtain a particular threshold of variance.

The example sample randomizer 404 generates a number of samples of the multinomial distribution equal to the number of misattribution matrix samples to be generated (block 706). For example, for each of the samples to be generated, the performs a number of trials using the multinomial distribution as the probabilities of success for the respective outcomes (e.g., Y-Y, Y-O, O-Y, O-O). The example sample randomizer 404 results in the determined number of samples.

The example distribution-to-matrix converter 406 converts the samples of the multinomial distribution to misattribution matrices (block 708). For example, the distribution-to-matrix converter 406 may use the successes of each outcome for the corresponding elements of the misattribution matrix sample. The example distribution-to-matrix converter 406 outputs the misattribution matrix samples (e.g., to the ratings data determiner 316 of FIG. 3).

The example instructions 700 of FIG. 7 then end. The instructions 700 may return control to a calling function such as block 610.

FIG. 8 is a flowchart representative of example machine readable instructions 800 that may be executed to implement the ratings data determiner 316 of FIGS. 3 and 5 to apply impression information to a misattribution matrix to obtain corrected impression information. The example instructions 800 of FIG. 8 may be executed to implement block 616 or block 620 of FIG. 6B to apply one or more vectors of audience members and/or impressions to one or more misattribution matrices.

The example attribution corrector 504 selects an attribution matrix (block 802). For example, the attribution corrector 504 selects the misattribution matrix stored in the misattribution data storage 304 of FIG. 3 or one of the generated misattribution matrices generated by the sample generator 310. The attribution corrector 504 determines the demographic groups represented in the selected misattribution matrix (block 804). For example, in the misattribution matrix of Table 1 above, the attribution corrector 504 identifies the demographic groups as including the Young and Old demographic groups.

The example attribution corrector 504 selects a demographic group from the represented demographic groups (block 806). Using the above example, the attribution corrector 504 may select the Young demographic group.

The attribution corrector 504 determines numbers of observed audience members and/or impressions that have been attributed to the selected demographic group in a vector of impression requests, that are attributable to each of the represented demographic groups based on the selected misattribution matrix (block 808). For example, the attribution corrector 504 may determine number of observed audience members that have been attributed to the Young demographic group in an expected audience members vector to be 1000 audience members. The example attribution corrector 504 determines, by applying the 1000 audience members to the Young-Young and Young-Old elements of the misattribution matrix, how many of the 1000 audience members are attributable to the Young demographic group and how many of the audience members are attributable to the Old demographic group. Using the example misattribution matrix 3 of Table 3 as the selected misattribution matrix, the example attribution corrector 504 determines there to be (74/111*1000)=667 audience members attributable to the Young demographic group, and (37/111*1000)=333 audience members attributable to the Old demographic group.

The example attribution corrector 504 determines whether there are additional demographic groups (block 810). If there are additional demographic groups (block 810), control returns to block 806 to select another demographic group from the represented demographic groups. In the example above, the attribution corrector 504 may repeat blocks 806 and 808 to determine there to be, for 2000 audience members in the Old demographic group of the expected audience members vector, (29/289*2000)=201 audience members attributable to the Young demographic group, and (160/289*1000)=1799 audience members attributable to the Old demographic group.

When there are no more demographic groups (block 810), the example attribution corrector 504 resets the status of each of the demographic groups to reconsider each of the demographic groups, and selects a demographic group from the represented demographic groups (block 812). After block 810, the example attribution corrector 504 may select the Young demographic group again. The example attribution corrector 504 calculates a sum of the number of observed audience members and/or impressions that are attributable to the selected demographic group, based on the determination of attribution (performed in block 808 for each of the demographic groups) (block 814). For example, the attribution corrector 504 calculates the sum of the audience members determined to be attributable to the Young demographic group from the observed Young demographic group (e.g., 667 audience members) and the audience members determined to be attributable to the Young demographic group from the observed Old demographic group (e.g., 201 audience members), for a total of (667+201)=868 audience members.

The attribution corrector 504 determines whether there are additional demographic groups (block 816). If there are additional demographic groups (block 816), the attribution corrector 504 returns to block 812 to select another demographic group. For example, the attribution corrector 504 may execute blocks 812, 814 to calculate the sum of audience members and/or impressions for the Old demographic group (e.g., 333+1799=2132 audience members). In the above example, the total number of audience members 868+2132=3000, which is the same number of audience members as were in the original expected audience member vector applied to the misattribution matrix.

When there are no more demographic groups (block 818), the example attribution corrector 504 generates a revised vector from the calculated sums of the audience members and/or the impressions (block 818). The revised vector may then be used to, for example, generating ratings information and/or perform statistical analyses of the demographic observations.

The example instructions 800 may then end. Control may be returned to a calling function, such as block 616 or block 620 of FIG. 6B. In some other examples, the instructions 800 may repeat for another misattribution matrix generated by the sample generator 310.

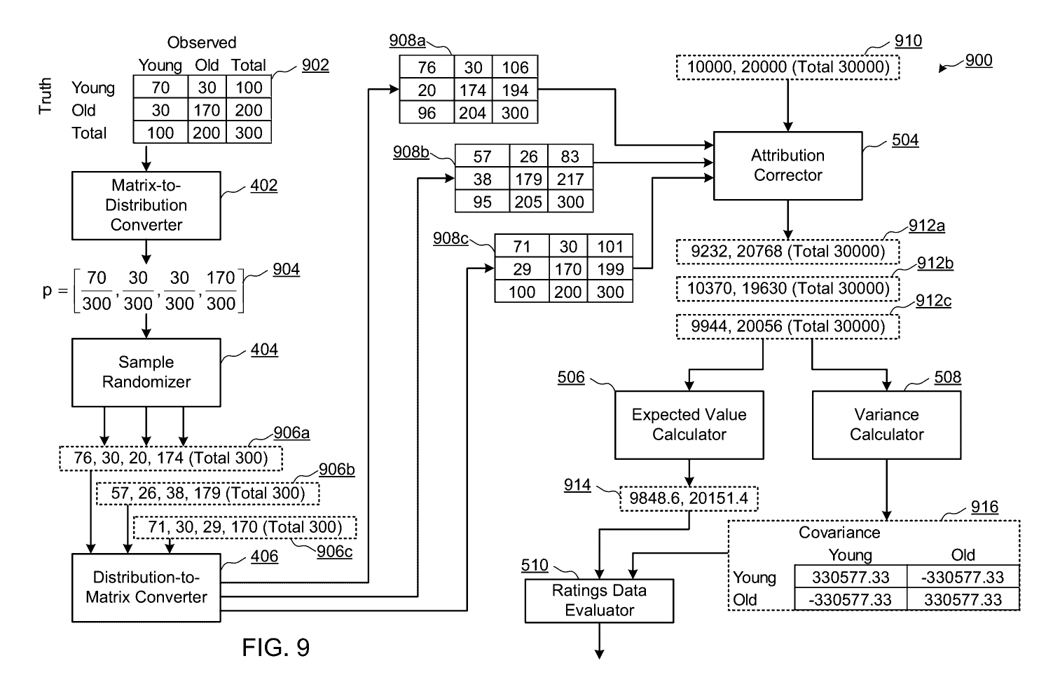

An example method 900 is illustrated in FIG. 9 performed with the structures of FIGS. 1, 3, 4, and 5. The example method 900 may be performed to process requests that are received from computing devices (e.g., consumer devices such as mobile devices) via a communications network. The requests indicate that access to media occurred at the respective devices. In response to one or more of such requests, an audience measurement entity sends a second request for demographic information, such as to a database proprietor. Examples of these requests are described above with reference to FIG. 1.

In the example of FIG. 9, a misattribution matrix 902 is obtained (e.g., from the misattribution data storage 304 of FIG. 3). The misattribution matrix describes a probability that an audience member observed to be in a first demographic group (e.g., Young, in the misattribution matrix 902) is attributable to a second demographic group (e.g., Old, in the misattribution matrix 902). The first demographic group may be the same or different as the second demographic group. Furthermore, while two demographic groups are illustrated in the example misattribution matrix 902, the misattribution matrix 902 may include any number of demographic group(s) organized using any number of personal characteristic(s).

In the example of FIG. 9, the method 900 reduces a probability error present in data used to generate the misattribution matrix 902. For example, the matrix-to-distribution converter 402 of FIG. 4 generates a multinomial distribution 904 from the misattribution matrix 902. The multinomial distribution 904 has four possibilities, each of the possibilities having a respective likelihood of being selected in a random selection. For example, the four possibilities in the multinomial distribution 904 have respective selection probabilities of 70/300 (e.g., 0.23333), 30/300 (e.g., 0.10), 30/300 (e.g., 0.10), and 170/300 (e.g., 0.56667).

The sample randomizer 404 of FIG. 4 generates samples 906a, 906b, 906c of the multinomial distribution 904. For example, the sample randomizer 404 may perform a number of trials using the multinomial distribution 904 to generate the first sample 906a. In the illustrated example, one trial includes pseudorandomly selecting one of the possible values, using the probabilities of selecting those values as defined in the multinomial distribution 904. While the sample randomizer 404 generates three samples 906a, 906b, 906c in the example of FIG. 9, the sample randomizer 404 may generate any number of samples (e.g., tens, hundreds, thousands, or more).

The example distribution-to-matrix converter 406 converts the samples 906a, 906b, 906c to a corresponding plurality of misattribution matrices 908a, 908b, 908c. The example misattribution matrices 908a, 908b, 908c are each identical in structure (i.e., they have same numbers of columns, rows, and cells) to the misattribution matrix 902, but have been randomized by the sampling process described above to generate the samples 906a, 906b, 906c to simulate randomness that can occur from sampling.

The example attribution corrector 504 of FIG. 5 operates on the misattribution matrices 908a, 908b, 908c using a vector 910. The vector 910 is based on observed data and includes one value for each of the demographic groups. Each of the values is a number of audience members (or impressions) observed by an AME during a media campaign (e.g., based on receiving media impression requests and obtaining corresponding demographic information from a database proprietor). So, in the example of FIG. 5, the vector 910 includes one value for a number of observed audience members in the Young group and one value for a number of observed audience members in the Old group. The example vector 910 is structured as an N×1 (or 1×N) matrix, where N is the number of demographic groups in the misattribution matrix 902.

The attribution corrector 504 applies the vector 910 to each of the plurality of misattribution matrices 908a, 908b, 908c to estimate corrected numbers 912a, 912b, 912c of audience members who are attributable to each of the demographic groups. For example, the attribution corrector 504 applies the vector 910 to the first one of the misattribution matrices 908a to generate the first corrected numbers 912a of audience members, applies the vector 910 to the second one of the misattribution matrices 908b to generate the second corrected numbers 912b of audience members, and applies the vector 910 to the third one of the misattribution matrices 908c to generate the third corrected numbers 912c of audience members. The attribution corrector 504 applies the vector 910 to a misattribution matrix 908a, 908b, 908c by performing a matrix multiplication of the vector 910 and the misattribution matrix to obtain corresponding result matrices of the corrected numbers 912a, 912b, 912c of audience members.

The example expected value calculator 506 calculates expected values 914 (e.g., mean or average values) of the corrected numbers of audience members, and the variance calculator 508 calculates a variance matrix 916 including the variances and/or covariances of the expected values 914. The expected values 914 and/or the variance matrix 916 may be used as ratings data by providing an accurate estimate of numbers of audience members as the expected values 914 and/or measurements of confidence in the estimate.

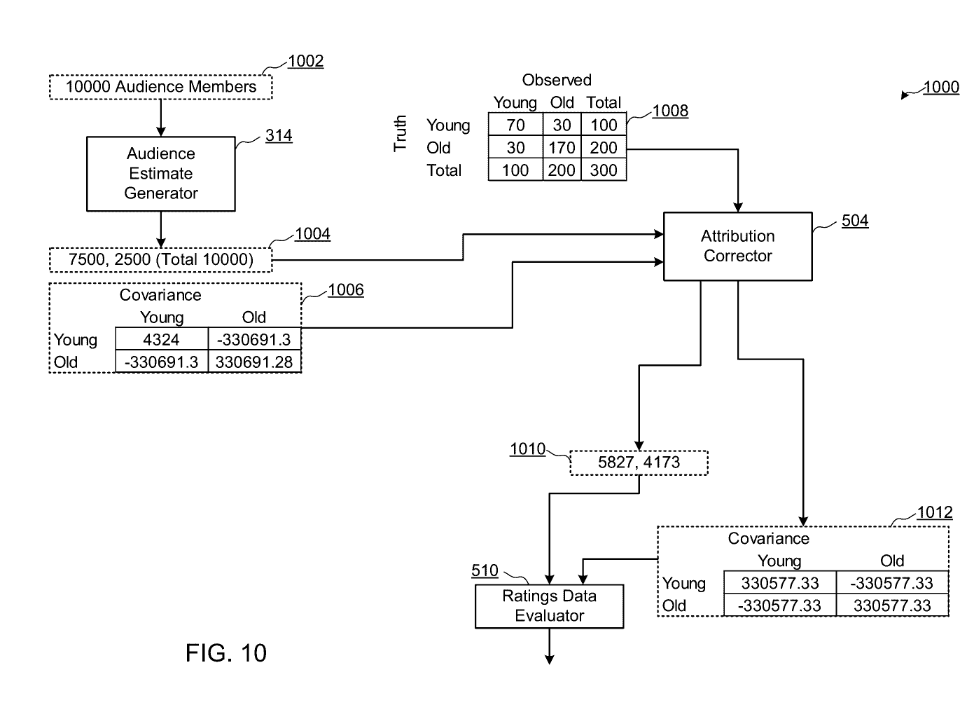

Another example method 1000 is illustrated in FIG. 10 performed with the structures of FIGS. 1, 3, 4, and 5. The example method 1000 may be performed to process requests that are received from computing devices (e.g., consumer devices such as mobile devices) via a communications network. The requests indicate that access to media occurred at the respective devices. In response to one or more of such requests, an audience measurement entity sends a second request for demographic information, such as to a database proprietor. Examples of these requests are described above with reference to FIG. 1.

The example method 1000 determines a first number 1002 of audience members who are associated with a first demographic group (of N demographic groups) based on the demographic information and based on the second requests received at the audience measurement entity. For example, the audience estimate generator 314 of FIG. 3 may receive a number of unique audience members counted at the audience measurement entity for an item of media and demographic information corresponding to the counted audience members. In some examples, the demographic information includes probabilities that each counted audience member falls into one of the demographic groups. The example audience estimate generator 314 determines estimated numbers 1004 of audience members who are in each of the demographic groups using the probabilities.

The example method 1000 reduces a probability error present in the demographic information (e.g., received from the database proprietor) by estimating a first number of audience members based on the demographic information and the second requests, determining a variance of the first number, determining a covariance between the first number and a second number of second audience members that are attributed to a second demographic group based on the demographic information and the second requests, and determining a third number of audience members to be attributed to the first demographic group based on the first number, the variance, and the covariance.

For example, the audience estimate generator 314 of FIG. 3 receives a number 1002 of unique audience members counted at the audience measurement entity and estimates a first number 1004 of audience members in each of the demographic groups using the probabilities from the database proprietor. An example of determining the first number 1004 of audience members is described in U.S. patent application Ser. No. 14/752,300.

The example audience estimate generator 314 also determines a covariance matrix 1006 of the first numbers 1004, including variances of the numbers of audience members and covariances between the numbers 1004 of audience members.

The example attribution corrector 504 obtains a misattribution matrix 1008. The misattribution matrix 1008 describes a probability that an audience member observed to be in a first one of the demographic groups (e.g., Young), based on the demographic information, is attributable to the second demographic group (e.g., Old). The example attribution corrector 504 applies the numbers of audience members 1004 attributed to each of the demographic groups to the misattribution matrix to estimate number of audience members that are attributable to each of the demographic groups. For example, the attribution corrector 504 may use Equation 6 described above to determine corrected numbers 1010 of audience members for each of the demographic groups. The example attribution corrector 504 also determines a corrected covariance matrix 1012 using Equation 7 described above.

By solving Equations 6 and 7, the example attribution corrector 504 corrects for probabilistic demographic bucket assignments, as well as random (but fixed) misattribution. For example, Equations 6 and 7 apply the misattribution matrix to a distribution of all defined age buckets (e.g., the expected values of the age buckets, a covariance matrix of the age buckets including the variances of the age buckets and the covariances between age buckets). The expected value describes the probability assigned to each age bucket (e.g., an average), and the covariance matrix describes both (1) the concentrations of those probabilities near the expected value, and (2) how the age buckets relate to each other. Each defined age bucket is applied to the misattribution matrix. Thus, Equations 6 and 7 describe an analytical solution for a hypothetical situation in which there are infinitely many combinations of age buckets in the range of ages (e.g., if the age buckets are subdivided into infinitesimally small buckets), and outputs expected values and a covariance matrix for the age buckets based on correction using the misattribution matrix.

The example ratings data evaluator 510 determines ratings data for the media based on the corrected numbers 1010 of audience members that are attributable to the demographic groups and/or based on the corrected covariance matrix 1012.

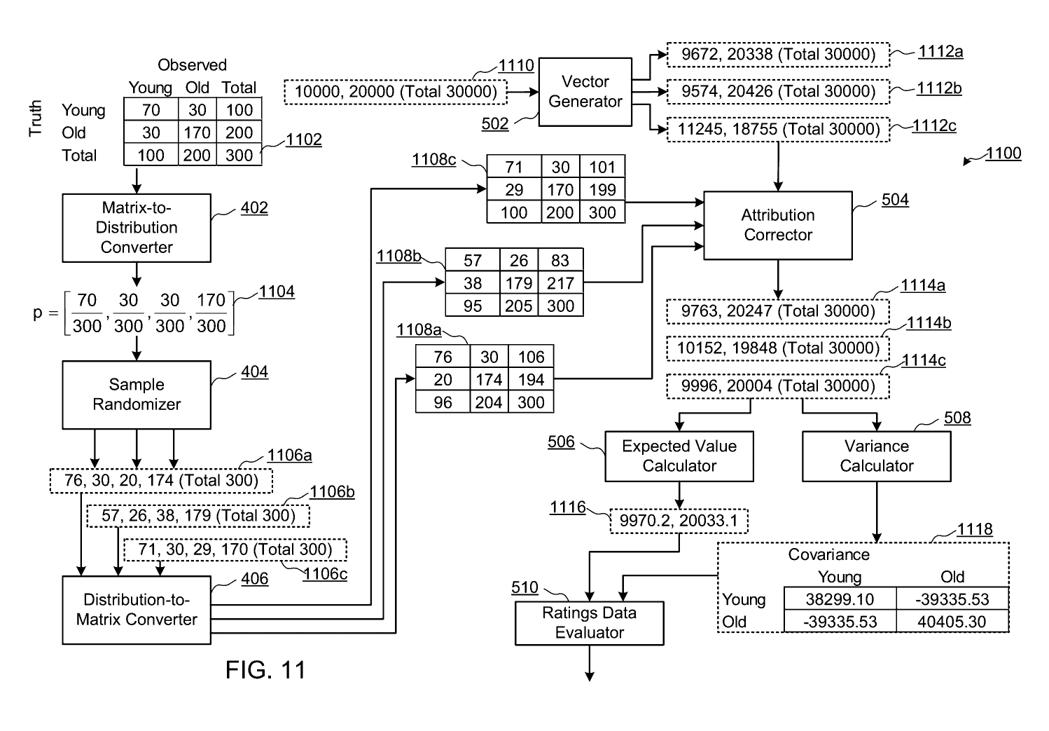

Another example method 1100 is illustrated in FIG. 11 performed with the structures of FIGS. 1, 3, 4, and 5. The example method 1100 may be performed to process requests that are received from computing devices (e.g., consumer devices such as mobile devices) via a communications network. The requests indicate that access to media occurred at the respective devices. In response to one or more of such requests, an audience measurement entity sends a second request for demographic information, such as to a database proprietor. Examples of these requests are described above with reference to FIG. 1.

In the example of FIG. 11, a misattribution matrix 1102 is obtained (e.g., from the misattribution data storage 304 of FIG. 3). The misattribution matrix 1102 describes a probability that an audience member observed to be in a first demographic group (e.g., Young, in the misattribution matrix 1102) is attributable to a second demographic group (e.g., Old, in the misattribution matrix 1102). The example misattribution matrix 1100 an N×N misattribution matrix 1102 describes probabilities that audience members who are observed to be in a first one of N demographic groups based on the demographic information are attributable to respective ones of the N demographic groups (including the first one of the N demographic groups). Furthermore, while two demographic groups are illustrated in the example misattribution matrix 1102, the misattribution matrix 1102 may include any number of demographic group(s) organized using any number of personal characteristic(s).

In the example of FIG. 11, the method 1100 reduces a first probability error present in a first number of audience members that are attributed to a first demographic group and a second probability error present in data used to generate the misattribution matrix 1102. To reduce the error, the method 1100 generates pseudorandom samples of the misattribution matrix 1102 using a distribution corresponding to the probabilities in the misattribution matrix 1102. For example, the matrix-to-distribution converter 402 of FIG. 4 generates a multinomial distribution 1104 from the misattribution matrix 1102. The multinomial distribution 1104 has four possibilities, each of the possibilities having a respective probability (or likelihood) of being selected in a random selection. For example, the four possibilities in the multinomial distribution 1104 have respective selection probabilities of 70/300 (e.g., 0.23333), 30/300 (e.g., 0.10), 30/300 (e.g., 0.10), and 170/300 (e.g., 0.56667).

The sample randomizer 404 of FIG. 4 generates samples 1106a, 1106b, 1106c of the multinomial distribution 1104. For example, the sample randomizer 404 may perform a number of trials using the multinomial distribution 1104 to generate the first sample 1106a. In the illustrated example, one trial includes pseudorandomly selecting one of the possible values, using the probabilities of selecting those values as defined in the multinomial distribution 1104. While the sample randomizer 404 generates three samples 1106a, 1106b, 1106c in the example of FIG. 11, the sample randomizer 404 may generate any number of samples (e.g., tens, hundreds, thousands, or more).

The example distribution-to-matrix converter 406 converts the samples 1106a, 1106b, 1106c to a corresponding plurality of misattribution matrices 1108a, 1108b, 1108c. The example misattribution matrices 1108a, 1108b, 1108c are each identical in structure (i.e., they have same numbers of columns, rows, and cells) to the misattribution matrix 1102, but have been randomized by the sampling process described above to generate the samples 1106a, 1106b, 1106c to simulate randomness that can occur from sampling.

The example method 1100 of FIG. 11 reduces the first probability error by calculating second numbers of audience members from the pseudorandom samples (e.g., the misattribution matrices 1108a, 1108b, 1108c) of the misattribution matrix by applying N numbers of audience members to the pseudorandom samples of the misattribution matrix. In the example method 1100, the N numbers of audience members correspond to impression requests and are attributed (e.g., by the AME 114 of FIG. 1) to corresponding ones of the N demographic groups based on demographic information (e.g., the demographic information provided by the database proprietor 116). For example, the vector generator 502 obtains a vector 1110 and generates random vectors 1112a, 1112b, 1112c from the vector 1110 to correspond to the misattribution matrices 1108a, 1108b, 1108c. The vector X10 is based on observed data and includes one value for each of the demographic groups. Each of the values is a number of audience members (or impressions) observed by an AME during a media campaign (e.g., based on receiving media impression requests and obtaining corresponding demographic information from a database proprietor).

To generate the random vectors 1112a, 1112b, 1112c, the vector generator 502 pseudorandomly generates vectors based on expected values of unique audience members, variance values, and/or covariance values, which are obtained as described in U.S. patent application Ser. No. 14/752,300.

The example attribution corrector 504 determines numbers of audience members for the media for corresponding ones of the N demographic groups based on the generated estimates of the audience members (e.g., the vectors 1112a, 1112b, 1112c). For example, the attribution corrector 504 of FIG. 5 operates on the misattribution matrices 1108a, 1108b, 1108c using the vectors 1112a, 1112b, 1112c.

The attribution corrector 504 applies the vectors 1112a, 1112b, 1112c to respective ones of the misattribution matrices 1108a, 1108b, 1108c to estimate corrected numbers 1114a, 1114b, 1114c of audience members, respectively, who are attributable to each of the demographic groups. For example, the attribution corrector 504 applies the vector 1112a to the first one of the misattribution matrices 1108a to generate the first corrected numbers 1114a of audience members, applies the vector 1112b to the second one of the misattribution matrices 1108b to generate the second corrected numbers 1112a of audience members, and applies the vector 1110 to the third one of the misattribution matrices 1108a to generate the third corrected numbers 1112a of audience members. The attribution corrector 504 applies the vectors 1112a, 1112b, 1112c to the misattribution matrices 1108a, 1108b, 1108c by performing matrix multiplications of corresponding one of the vectors 1112a, 1112b, 1112c and the misattribution matrices 1108a, 1108b, 1108c to obtain corresponding result matrices of the corrected numbers 1114a, 1114b, 1114c of audience members.

The example method 1100 determines ratings data for the media based on the number of audience members for the media for each of the N demographic groups The example expected value calculator 506 calculates expected values 1116 (e.g., mean or average values) of the corrected numbers of audience members, and the variance calculator 508 calculates a variance matrix 1118 including the variances and/or covariances of the expected values 1116. The expected values 1116 and/or the variance matrix 1118 may be used as ratings data by providing an accurate estimate of numbers of audience members as the expected values 1116 and/or measurements of confidence in the estimate.

FIG. 12 is a block diagram of an example processor platform 1200 structured to execute the instructions of FIGS. 6A-6B, 7, and/or 8 to implement the probabilistic ratings determiner 120a of FIGS. 2, 3, 4, and/or 5. The processor platform 1200 can be, for example, a server, a personal computer, a mobile device (e.g., a cell phone, a smart phone, a tablet such as an iPad™), or any other type of computing device.

The processor platform 1200 of the illustrated example includes a processor 1212. The processor 1212 of the illustrated example is hardware. For example, the processor 1212 can be implemented by one or more integrated circuits, logic circuits, microprocessors or controllers from any desired family or manufacturer. The example processor 1212 of FIG. 12 may implement the data interface 302, the example misattribution data storage 304, the example population attributes storage 306, the example classification probabilities storage 308, the example sample generator 310, the example classification probability retriever 312, the example audience estimate generator 314, the example ratings data determiner 316, the example ratings data reporter 318, the example matrix-to-distribution converter 402, the example sample randomizer 404, the example distribution-to-matrix converter 406, the example vector generator 502, the example attribution corrector 504, the example expected value calculator 506, the example variance calculator 508, the example ratings data evaluator 510 and/or, more generally, the example probabilistic ratings determiner 120a of FIGS. 2, 3, 4, and/or 5.

The processor 1212 of the illustrated example includes a local memory 1213 (e.g., a cache). The processor 1212 of the illustrated example is in communication with a main memory including a volatile memory 1214 and a non-volatile memory 1216 via a bus 1218. The volatile memory 1214 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 1216 may be implemented by flash memory and/or any other desired type of memory device. Access to the main memory 1214, 1216 is controlled by a memory controller.

The processor platform 1200 of the illustrated example also includes an interface circuit 1220. The interface circuit 1220 may be implemented by any type of interface standard, such as an Ethernet interface, a universal serial bus (USB), and/or a PCI express interface.

In the illustrated example, one or more input devices 1222 are connected to the interface circuit 1220. The input device(s) 1222 permit(s) a user to enter data and commands into the processor 1212. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 1224 are also connected to the interface circuit 1220 of the illustrated example. The output devices 1224 can be implemented, for example, by display devices (e.g., a light emitting diode (LED), an organic light emitting diode (OLED), a liquid crystal display, a cathode ray tube display (CRT), a touchscreen, a tactile output device, a light emitting diode (LED), a printer and/or speakers). The interface circuit 1220 of the illustrated example, thus, typically includes a graphics driver card, a graphics driver chip or a graphics driver processor.

The interface circuit 1220 of the illustrated example also includes a communication device such as a transmitter, a receiver, a transceiver, a modem and/or network interface card to facilitate exchange of data with external machines (e.g., computing devices of any kind) via a network 1226 (e.g., an Ethernet connection, a digital subscriber line (DSL), a telephone line, coaxial cable, a cellular telephone system, etc.).

The processor platform 1200 of the illustrated example also includes one or more mass storage devices 1228 for storing software and/or data. Examples of such mass storage devices 1228 include floppy disk drives, hard drive disks, compact disk drives, Blu-ray disk drives, RAID systems, and digital versatile disk (DVD) drives. The example mass storage devices 1228 may implement one or more of the misattribution data storage 304, the population attributions storage 306, and/or the classification probabilities storage 308.

The coded instructions 1232 of FIGS. 6A-6B, 7, and 8 may be stored in the mass storage device 1228, in the volatile memory 1214, in the non-volatile memory 1216, and/or on a removable tangible computer readable storage medium such as a CD or DVD.

Disclosed examples improve the technical field of audience measurement for example, as it relates to monitoring media presented on computing devices, including mobile devices. In particular, disclosed examples improve the accuracy of media measurements by correcting for sampling errors and/or biases in data calibration tools, such as the misattribution matrix. Accuracy is important in audience measurement metrics, as inaccuracy can substantially affect the value of media properties.

Additionally, examples disclosed herein apply misattribution matrices to observed impression data more efficiently and more accurately by reducing the number of computational steps involved in performing the calculations (e.g., reducing (e.g., eliminating) normalization and/or data scaling steps) while simultaneously improving the accuracy of the calculations, when compared with prior methods of applying misattribution matrices. Reducing or eliminating normalization and/or data scaling is achieved by disclosed examples because such disclosed examples output audience counts and/or impression counts that match the input audience counts and/or impression counts. As such, scaling and/or normalization are unnecessary in such examples. Therefore, disclosed methods can perform these operations without performing a normalization process and/or without performing data scaling. Eliminating these processes reduces the burden on a processor as it does not need to execute the instructions associated with performing those operations.

Further, examples disclosed herein improve the efficiency and accuracy of evaluating network-based media impression information. Collection and evaluation of network-based media impression information of disclosed examples is an inherently technical process, because collection the media impression information (e.g., impression counts, audience counts) and obtaining demographic information from database proprietors necessarily involves network communications between (1) media server(s), (2) audience measurement server(s), (3) client/consumer device(s) on which the media is presented, and/or (4) server(s) of the database proprietor(s) that determine the demographic information associated with the client/consumer devices based on prior network-based communications with those devices. Moreover, these communications are performed automatically, without human intervention in the background of ordinary requests to access Internet-based media. Accordingly, obtaining the network-collected demographic data and correcting for probability error(s) present in the network-collected demographic data is a technical process.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

1. A method to determine ratings data, comprising:
sending, from a processor of an audience measurement entity, a first request for demographic information corresponding to second requests received at the audience measurement entity;
determining, by executing a first instruction with the processor, a first number of audience members who are associated with a first demographic group based on the demographic information and based on the second requests received at the audience measurement entity;
reducing an error present in a misattribution matrix, the misattribution matrix describing a probability that an audience member observed to be in the first demographic group is actually in a second demographic group, reducing the error by:
generating, by executing a second instruction with the processor, a multinomial distribution from the misattribution matrix;
generating, by executing a third instruction with the processor, samples of the multinomial distribution;
converting, by executing a fourth instruction with the processor, the samples to a plurality of misattribution matrices; and
applying, by executing a fifth instruction with the processor, the first number of audience members to the plurality of misattribution matrices to estimate a second number of audience members who are attributable to the second demographic group; and
determining, by executing a sixth instruction with the processor, ratings data for media based on the second number of audience members who are attributable to the second demographic group.

2. A method as defined in claim 1, wherein applying the first number of audience members to the plurality of misattribution matrices includes performing a matrix multiplication of a vector and each of the plurality of misattribution matrices to obtain corresponding result matrices, the vector including the first number of audience members, the corresponding result matrices including estimates of the second number of audience members.

3. A method as defined in claim 1, further including:
estimating a first expected number of audience members that are attributable to the first demographic group based on the applying of the first number of audience members to a first one of the plurality of misattribution matrices;
determining a variance of the first expected number, and
determining a covariance between the first expected number and a second expected number of third audience members that are attributable to the second demographic group based on the applying of the first number of audience members to the first one of the plurality of misattribution matrices.

4. A method as defined in claim 3, further including estimating the first expected number, determining the variance of the first expected number, and determining the covariance of the first expected number for each of the plurality of misattribution matrices.

5. A method as defined in claim 1, further including:
applying a third number of audience members to the plurality of misattribution matrices to estimate a fourth number of audience members who are attributable to the first demographic group, the third number of audience members being attributed to the second demographic group, the third number of audience members corresponding to the second requests received at the audience measurement entity;
applying a fifth number of audience members to the plurality of misattribution matrices to estimate a sixth number of audience members who are attributable to the first demographic group, the fifth number of audience members being attributed to the first demographic group, the fifth number of audience members corresponding to the second requests received at the audience measurement entity; and
applying a seventh number of audience members to the plurality of misattribution matrices to estimate an eighth number of audience members who are attributable to the second demographic group, the seventh number of audience members being attributed to the second demographic group, the seventh number of audience members corresponding to the second requests received at the audience measurement entity, a first sum of audience members attributed to ones of the first and second demographic groups being equal to a second sum of audience members determined to be attributable to the ones of the first and second demographic groups, the first sum including the first number, the third number, the fifth number, and the seventh number, and the second sum including the second number, the fourth number, the sixth number, and the eighth number, the ratings data being based on the first sum and the second sum.

6. A method as defined in claim 1, wherein the generating of the ratings data reduces or eliminates at least one of a normalization process or a data scaling process.

7. A method as defined in claim 1, wherein the demographic information includes the first number of audience members attributed to the first demographic group who correspond to the second requests.

8. A device to determine ratings data for online accessible media, comprising:
a data interface to send a first request for demographic information corresponding to second requests received at an audience measurement entity;
an audience estimate generator to determine a first number of audience members who are associated with a first demographic group based on the demographic information and based on the second requests received at the audience measurement entity;
a matrix-to-distribution converter to generate a multinomial distribution from a misattribution matrix, the misattribution matrix describing a probability that an audience member observed to be in the first demographic group is actually in a second demographic group;
a sample randomizer to generate samples of the multinomial distribution;
a distribution-to-matrix converter to convert the samples to a plurality of misattribution matrices;
an attribution corrector to apply the first number of audience members to the plurality of misattribution matrices to estimate a second number of audience members who are attributable to the second demographic group to thereby reduce an error present in the misattribution matrix; and
a ratings data determiner to determine ratings data for media based on the second number of audience members who are attributable to the second demographic group.

9. A device as defined in claim 8, further including:
an expected value calculator to estimate a first expected number of audience members that are attributable to the first demographic group based on the applying of the first number of audience members to a first one of the plurality of misattribution matrices; and
a variance calculator to:
determine a variance of the first expected number; and
determine a covariance between the first expected number and a second expected number of audience members that are attributable to the second demographic group based on the applying of the first number of audience members to the first one of the plurality of misattribution matrices.

10. A device as defined in claim 9, wherein the expected value calculator is to estimate the first expected number and the variance calculator is to determine the variance of the first expected number and determine the covariance of the first expected number for each of the plurality of misattribution matrices.

11. A device as defined in claim 8, wherein the attribution corrector is to:
apply a third number of audience members to the plurality of misattribution matrices to estimate a fourth number of audience members who are attributable to the first demographic group, the third number of audience members being attributed to the second demographic group, the third number of audience members corresponding to the second requests;
apply a fifth number of audience members to the plurality of misattribution matrices to estimate a sixth number of audience members who are attributable to the first demographic group, the fifth number of audience members being attributed to the first demographic group, the fifth number of audience members corresponding to the second requests; and
apply a seventh number of audience members to the plurality of misattribution matrices to estimate an eighth number of audience members who are attributable to the second demographic group, the seventh number of audience members being attributed to the second demographic group, the seventh number of audience members corresponding to the second requests, a first sum of audience members attributed to ones of the first and second demographic groups being equal to a second sum of audience members determined to be attributable to the ones of the first and second demographic groups, the first sum including the first number, the third number, the fifth number, and the seventh number, and the second sum including the second number, the fourth number, the sixth number, and the eighth number, the ratings data being based on the first sum and the second sum.

12. A device as defined in claim 8, wherein the attribution corrector is to apply the first number of audience members to the plurality of misattribution matrices by, for each of the misattribution matrices, determining respective portions of the first number of audience members that 1) have been attributed to the first demographic group and 2) are attributable to each of a plurality of demographic groups, including the first demographic group, based on the misattribution matrix.

13. A device as defined in claim 8, wherein the demographic information includes the first number of audience members attributed to the first demographic group that correspond to the second requests.

14. A tangible computer readable storage medium comprising computer readable instructions which, when executed, cause a processor of an audience measurement entity to at least:
send a first request for demographic information corresponding to second requests received at the audience measurement entity;
determine a first number of audience members who are associated with a first demographic group based on the demographic information and based on the second requests received at the audience measurement entity;
reduce an error present in a misattribution matrix, the misattribution matrix describing a probability that an audience member observed to be in the first demographic group is actually in a second demographic group, reducing the error by:
generate a multinomial distribution from the misattribution matrix;
generate samples of the multinomial distribution;
convert the samples to a plurality of misattribution matrices; and
apply the first number of audience members to the plurality of misattribution matrices to estimate a second number of audience members who are attributable to the second demographic group; and
determine ratings data for media based on the second number of audience members who are attributable to the second demographic group.

15. A storage medium as defined in claim 14, wherein the instructions are further to cause the processor to:
estimate a first expected number of audience members that are attributable to the first demographic group based on the applying of the first number of audience members to a first one of the plurality of misattribution matrices;
determine a variance of the first expected number; and
determine a covariance between the first expected number and a second expected number of audience members that are attributable to the second demographic group based on the applying of the first number of audience members to the first one of the plurality of misattribution matrices.

16. A storage medium as defined in claim 15, wherein the instructions are further to cause the processor to estimate the first expected number, determining the variance of the first expected number, and determining the covariance of the first expected number for each of the misattribution matrices.

17. A storage medium as defined in claim 14, wherein the instructions are further to cause the processor to:
apply a third number of audience members to the plurality of misattribution matrices to estimate a fourth number of audience members who are attributable to the first demographic group, the third number of audience members being attributed to the second demographic group, the third number of audience members corresponding to the second requests received at the audience measurement entity;
apply a fifth number of audience members to the plurality of misattribution matrices to estimate a sixth number of audience members who are attributable to the first demographic group, the fifth number of audience members being attributed to the first demographic group, the fifth number of audience members corresponding to the second requests received at the audience measurement entity; and
apply a seventh number of audience members to the plurality of misattribution matrices to estimate an eighth number of audience members who are attributable to the second demographic group, the seventh number of audience members being attributed to the second demographic group, the seventh number of audience members corresponding to the second requests received at the audience measurement entity, a first sum of audience members attributed to ones of the first and second demographic groups being equal to a second sum of audience members determined to be attributable to the ones of the first and second demographic groups, the first sum including the first number, the third number, the fifth number, and the seventh number, and the second sum including the second number, the fourth number, the sixth number, and the eighth number, the ratings data being based on the first sum and the second sum.

18. A storage medium as defined in claim 14, wherein the instructions are further to cause the processor to applying the first number of audience members to the plurality of misattribution matrices includes performing a matrix multiplication of the first number of audience members and each of the plurality of misattribution matrices to obtain corresponding result matrices, the corresponding result matrices including estimates of the second number of audience members.

19. A storage medium as defined in claim 14, wherein the instructions are to cause the processor to apply the first number of audience members to the plurality of misattribution matrices by, for each of the misattribution matrices, determining respective portions of the first number of audience members that 1) have been attributed to the first demographic group and 2) are attributable to each of a plurality of demographic groups, including the first demographic group, based on the misattribution matrix.

20. A storage medium as defined in claim 14, wherein the demographic information includes the number of audience members attributed to the first demographic group that correspond to the second requests.

21-24. (canceled)
